(19) United States
(12) Patent Application Publication
(10) Pub. No.: US 2006/0277078 A1
(43) Pub. Date: Dec. 7, 2006

(54) Reservation changing system

(76) Inventors: Motoji Ohmori, Hirakata-shi (JP); Toshihisa Nakano, Neyagawa (JP); Atsushi Saso, Yokohama-shi (JP)

Correspondence Address: WENDEROTH, LIND & PONACK L.L.P., 2033 K. STREET, NW, SUITE 800, WASHINGTON, DC, 20006, US

(21) Appl. No.: 10/565,724

(22) PCT Filed: Jul. 30, 2004
(86) PCT No.: PCT/JP04/11295

§ 371 Date: Jun. 19, 2006

(30) Foreign Application Priority Data
Aug. 5, 2003 (JP) 2003-286788

(51) Int. Cl. G06Q 10/00

(52) U.S. Cl. 705/5

(57) ABSTRACT

A reservation changing system provides diverse services. A memory card 200 obtains, via a mobile telephone 400, a distance from a present location to a boarding station for a train for which a reservation has been made, and judges whether to perform a train reservation change search depending on the relationship between the obtained distance and a time remaining until a departure time of the train. When it is judged that a reservation change search is to be performed, the memory card 200 obtains an expected arrival time at the station from a timetable server apparatus 500, compares the obtained expected arrival time with the departure time, and when a time margin between the two times is insufficient, the memory card 200 instructs a reservation center apparatus 300, via the mobile telephone 400, to change the reservation, and receives and stores reservation information.

### TECHNICAL FIELD

The present invention relates to a technique for changing a reservation for purchase of a commodity, a service, or the like.

### BACKGROUND ART

In recent years, developments have been made in techniques for automation of reservation and purchase of tickets for aeroplanes, trains, theatres, and the like, and in techniques for automation of checking of entry to and exit from such facilities.

According to one conventional technique which has an object of improving convenience in use of transportation facilities by enabling users to obtain required information easily at the time of purchasing a ticket, after inputting a destination into a ticket vending machine, the user selects travel conditions from among travel conditions for reaching the destination, and is able to obtain information such as which is the cheapest way or the fastest way to reach the destination, as well as having a ticket issued that corresponds the input conditions.

Another conventional technique is an automated payment system and automated ticket inspection machine where functions of both a commuter ticket and a prepaid card are incorporated into a non-contact IC card, thereby eliminating the need for the automated ticket inspection machine to have a structure for conveying tickets and commuter passes therethough. The non-contact IC card includes prepaid means, and stores information of a commuter pass. The automated ticket inspection machine reads the information without direct contact with the non-contact IC card, and automatically deducts the fare from the prepaid balance if necessary, when boarding or alighting of the transport is authorized. The automated ticket inspection machine then opens its gate so that the passenger may pass though.

A further conventional technique is a method for canceling a seat reservation that is no longer required when it is detected that the passenger who held the reservation has actually taken an earlier train, and selling the seat to another passenger, with conventional equipment, or with relatively little investment in equipment. An automated ticket inspection machine reads a magnetized ticket for the reserved seat, compares the present time with the departure time of the train for which the reservation has been made, and if the present time is at least a predetermined time before the departure time, judges that the passenger will take a different train. The automated ticket inspection machine communicates with a host computer to cancel the reserved seat, makes a mark on the surface of the ticket indicating that the seat has been cancelled, and also writes that the seat has been cancelled to a magnetic part of the ticket. Furthermore, if a passenger travels in a non-reserved seat instead of the seat for which the reservation has been made, the user is able to input the seat reservation ticket into a passenger-operated terminal which refunds the difference (or part of the difference) between the fares. In either case, when the process for canceling the boarding station seat reservation is complete, the seat reservation is then sold to another passenger.

Yet a further conventional technique is one with an object of improving unity of a check system in which a mobile telephone is used to reserve tickets for an aeroplane or an express train as well as for a play or the like, by enabling automated gates to be passed through without a ticket after a reservation has been made, thereby eliminating the trouble of receiving a reserved ticket, and automating the process from reserving tickets through to payment and passing through the gates, and also enabling use of a unified recording medium is used for the ticket reservation information and the like. This technique uses a mobile telephone in which a removable IC card is mounted to control the automated gates. The IC card outputs information such as the stored ticket reservation information to the automated gates which performs gate control, and receives input of information from the automated gates, uses information received from the automated gates to update or delete the original information, and also outputs the received information to a mobile telephone or the like.

Furthermore, another conventional technique is one which has an object of prompting a user to re-use a specific means of transport that the user has already used. When discount application past data is managed by an IC card, the reservation terminal reads past data for a discount application period from the IC card which is inserted in an IC card reader by a purchaser, and further reads present purchase request contents input by the purchaser via the input apparatus. Next, the reservation terminal creates a request telegram based on the past data and the present purchase request contents, and transmits the request telegram to a host computer. The host computer refers to a seat management database and judges whether a requested seat exists. When such a seat does exist, the host computer judges whether a discount is applicable based on the past data of the discount application period transmitted from the reservation terminal and the present request contents, and after calculating the discount, calculates the fare, and transmits a response telegram in which is stored ticket information and discount application information, to the reservation terminal.

However, although tickets can be easily purchased and reservations according to the conventional techniques, there are demands for more diverse services when using transport, theatres and the like.

### DISCLOSURE OF THE INVENTION

In response to such demands, an object of the present invention is to provide a reservation changing system, an IC card, a mobile terminal apparatus, a reservation changing method, and a computer program that enable a reservation for purchase of a ticket for transport that provides a transportation service to be changed reliably.

In order to achieve the stated object, the present invention is a reservation changing system for changing a reservation for purchasing a ticket for transport that provides a transportation service, the reservation changing system including a mobile terminal apparatus, an information provision server apparatus, and a reservation server apparatus, wherein the mobile terminal apparatus includes a secure unit, stores, in the secure unit, first reservation information indicating the reservation and including a boarding location where the transport is to be boarded and a departure time of the transport, obtains a present location of the mobile terminal apparatus, extracts the boarding location from the first reservation information, and transmits the obtained present location and the extracted boarding location to the information provision server apparatus, the information provision server apparatus receives the present location and the boarding location, obtains, with use of the received present location and boarding location, an expected arrival time of a user at the boarding location or an approximate time for the user to arrive at the boarding location, and transmits the obtained expected arrival time or approximate time to the mobile terminal apparatus, the mobile terminal apparatus, in the secure unit, receives the expected arrival time, or receives the approximate time and calculates an expected arrival time, and, when a time margin between the expected arrival time and the departure time included in the first reservation information is insufficient, transmits, to the reservation server apparatus, second reservation information indicating a reservation for a ticket for a transport that departs later than the departure time, and stores the second reservation information in place of the first reservation information, and the reservation server apparatus receives the second reservation information, and stores the received second reservation information in place of the first reservation information.

According to the stated structure, when the time margin between the received expected arrival time and the departure time is insufficient, the mobile terminal apparatus judges that the reservation information is to be changed. Therefore, the judgment of whether to change the reservation information is made reliably.

Here, the mobile terminal apparatus may determine that the time margin is insufficient when a margin-added expected arrival time is later than the departure time, the margin-added expected arrival time having been obtained by adding a margin value to the expected arrival time.

According to the stated structure, the received expected arrival time and departure time are compared, and when the expected arrival time is later than the departure time, it is judged that the reservation information is to be changed. Therefore, the judgment of whether to change the reservation information is made reliably.

Here, the secure unit of the mobile communication terminal may be a portable IC card.

According to the stated structure, the secure unit is portable, and therefore the secure unit can be used in other apparatuses.

Here, the secure unit of the mobile terminal apparatus may perform communication with the information provision server apparatus and with the reservation server apparatus via a first communication interface, and the secure unit of the mobile terminal apparatus may further perform, with an external apparatus via a second communication interface, a procedure for boarding transport, with use of the stored second reservation information.

According to the stated structure, a procedure for boarding transport can be made using the second reservation information for a newly-made reservation.

Here, the external apparatus may be a ticket issuing apparatus that issues tickets for transport, the secure unit of the mobile terminal apparatus may output the stored second reservation information to the ticket issuing apparatus, and the ticket issuing apparatus may receive the second reservation information, and issues a ticket for the transport for which the reservation has been made according to the received second reservation information.

According to the stated structure, a ticket for transport can be issued by the ticket issuing apparatus by transmitting the second reservation information for a newly-made reservation to the ticket issuing apparatus.

Here, the external apparatus may be a ticket inspection apparatus that inspects tickets at an entry point for boarding transport, the secure area of the mobile terminal apparatus may output the stored second reservation information to the ticket inspection apparatus, and the ticket inspection apparatus may receive the second reservation information, inspects content of the received second reservation information, and control opening and closing of a gate of the ticket inspection apparatus according to a result of the inspection.

According to the stated structure, the ticket inspection apparatus inspects the second reservation information for a newly-made reservation and controls opening and closing of the gate, according to the second reservation information being transmitted to the ticket inspection apparatus.

### BRIEF DESCRIPTION OF THE DRAWINGS

FIG. 1 shows the structure of a transport ticket system 1;

FIG. 2 is a block diagram showing the structure of a personal computer 100;

FIG. 3 shows examples of screens displayed by a display unit 105;

FIG. 4 is a block diagram showing the structure of a memory card 200;

FIG. 5 shows the structure of a reservation information tale 232;

FIG. 6 shows the data structure of a ticket issue information table 234;

FIG. 7 is a block diagram showing the structure of a reservation center apparatus 300;

FIG. 8 shows the data structure of a train reservation table 331;

FIG. 9 shows the data structure of a reservation user table 332;

FIG. 10 shows the data structure of a train service schedule information table 333;

FIG. 11 shows the data structure of a train service state information table 334;

FIG. 12 is a block diagram showing the structure of a mobile telephone 400;

FIG. 13 shows examples of screens displayed by a display unit 404;

FIG. 14 shows examples of screens displayed by the display unit 404;

FIG. 15 is a block diagram showing the structure of a timetable server apparatus 500;

FIG. 16 shows the data structure of a station information table 531;

FIG. 17 shows the data structure of an inter-station timetable 532;

FIG. 18 is a block diagram showing the structure of a ticket vending machine 600;

FIG. 19 is a block diagram showing the structure of an automated ticket inspection machine 700;

FIG. 20 is a flowchart showing operations in the transport ticket system 1, and continues in FIG. 21;

FIG. 21 is a flowchart showing operations in the transport ticket system 1, and continues from FIG. 20;

FIG. 22 is a flowchart showing operations for device authentication between an authentication unit 204 of the memory card 200 and an authentication unit 307 of the reservation center apparatus 300;

FIG. 23 is a flowchart showing operations for changing a reservation in the transport ticket system 1, and continues in FIG. 24;

FIG. 24 is a flowchart showing operations for changing a reservation in the transport ticket system 1, and continues in FIG. 25;

FIG. 25 is a flowchart showing operations for changing a reservation in the transport ticket system 1, and continues in FIG. 26;

FIG. 26 is a flowchart showing operations for changing a reservation in the transport ticket system 1, and continues in FIG. 27;

FIG. 27 is a flowchart showing operations for changing a reservation in the transport ticket system 1, and continues in FIG. 28;

FIG. 28 is a flowchart showing operations for changing a reservation in the transport ticket system 1, and continues in FIG. 29;

FIG. 29 is a flowchart showing operations for changing a reservation in the transport ticket system 1, and continues from FIG. 28;

FIG. 30 is a flowchart showing operations for issuing a ticket in the transport ticket system 1, and continues in FIG. 31;

FIG. 31 is a flowchart showing operations for issuing a ticket in the transport ticket system 1, and continues from FIG. 30;

FIG. 32 is a flowchart showing operations for ticket inspection machine in the transport ticket system 1, and continues in FIG. 33;

FIG. 33 is a flowchart showing operations for ticket inspection machine in the transport ticket system 1, and continues from FIG. 32;

FIG. 34 is a block diagram showing the structure of a mobile telephone 400a; and

FIG. 35 is a block diagram showing the structure of a mobile telephone 400b and a memory card 200b.

### BEST MODE FOR CARRYING OUT THE INVENTION

1. Transport Ticket System 1

The following describes a transport ticket system 1 as an embodiment of the present invention.

1.1 Structure of the Transport Ticket System 1

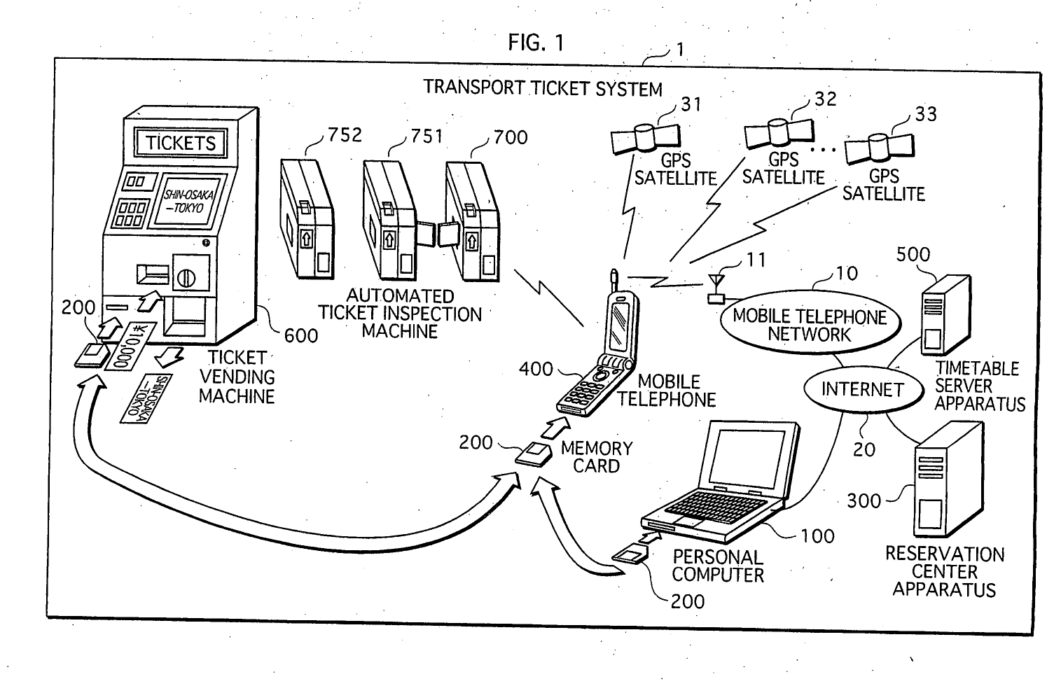

The transport ticket system 1, as shown in FIG. 1, is composed of a personal computer 100, a portable memory card 200, a reservation center apparatus 300, a mobile telephone 400, a timetable server apparatus 500, a ticket vending machine 600, and automated ticket inspection machines 700, 751, and 752.

The personal computer 100 is connected to the reservation center apparatus 300 via the Internet 20. The memory card 200 is mounted in the personal computer 100 by the user. According to user operations, the personal computer 100 reserves a seat for a train with the reservation center apparatus 300, receives reservation information indicating the reservation, and writes the received reservation information to the memory card 200.

Next, the user mounts the memory card 200 in the mobile telephone 400 and leaves sets out for travel, taking with him/her the mobile telephone 400 in which the memory card 200 has been mounted.

The mobile telephone 400 calculates the present location (latitude and longitude) of the mobile telephone 400 with use of information received from the GPS satellites 31, 32, 33, etc., and the memory card 200 obtains the present position from the mobile telephone 400. The mobile telephone 400 is connected to the timetable server apparatus 500 via a radio base station 11, a mobile telephone network 10, and the Internet 20. The memory card 200 obtains the distance from the present location of the mobile telephone 400 to the station from which the user will board the train on which he/she has a reservation (hereinafter, this station is referred to as the “boarding station”), from the time table server apparatus 500 via the mobile telephone 400, and judges whether or not to perform a search to change the reservation (hereinafter referred to as a “reservation change search”), according to the relationship between the obtained distance and the time remaining until the departure time of the train. Here, a reservation change search denotes performing a search to find out whether any train services subsequent to the train for which the user already holds a reservation are usable.

On judging that a reservation change search is to be performed, the memory card 200 obtains an expected arrival time of the user at the departure station from the timetable server apparatus 500 via the mobile telephone 400, compares the obtained expected arrival time with the departure time of the train, and if a sufficient time margin remains to catch the train, does not change the reservation. If a sufficient time margin does not remain, the memory card 200 instructs the reservation center apparatus 300′, via the mobile telephone 400, to change the reservation. The mobile telephone 400 obtains a list of trains which are usable, receives a selection of one of the trains from the user, and makes a reservation on the selected train. The memory card 200 internally stores reservation information showing the new reservation, and deletes the boarding station reservation information.

On arriving at the departure station, the user mounts the memory card 200 in the ticket vending machine 600 which is located at the station. The ticket vending machine 600 reads the reservation information from the memory card 200, generates ticket issue information that includes identical content to the ticket for the train with use of the read reservation information, and writes the generated ticket issue information to the memory card 200. The user pays a corresponding fare at this point. In this way, the ticket for the train is sold.

The user mounts the memory card in the mobile telephone 400, and passes between the automated ticket inspection machines 700 and 751 while holding the mobile telephone 400 in which the memory card 200 is mounted. Here, the user holds the mobile telephone 400 close to the automated ticket inspection machine 700, and the mobile telephone 400 performs short-distance radio communication with the automated ticket inspection machine 700. The automated ticket inspection machine 700 reads the ticket issue information from the memory card 200 via the mobile telephone 400, checks the read ticket issue information, and controls the gate of the automated ticket inspection machine 700 to be open or closed, depending on the result of the check.

1.2 Personal Computer 100

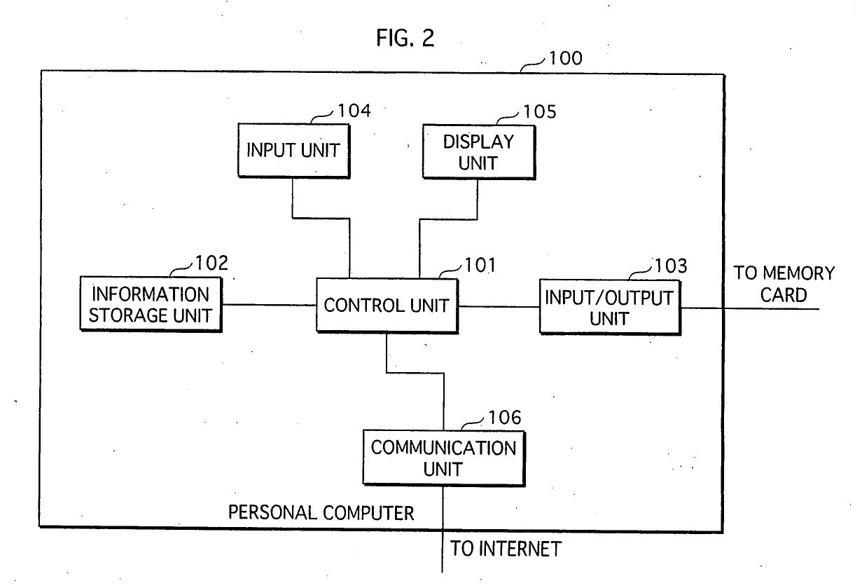

The personal computer 100, as shown in FIG. 2, is composed of a control unit 101, an information storage unit 102, an input/output unit 103, an input unit 104, a display unit 105, and a communication unit 106.

The personal computer 100 is, specifically, a computer system including microprocessor, a ROM, a RAM, a hard disk unit, a keyboard, a mouse, a liquid crystal display unit, a LAN connection unit, and a bus. Computer programs are stored in the RAM or the hard disk unit, and the personal computer 100 achieves its functions by the microprocessor operating according to the computer programs.

(1) Display Unit 105

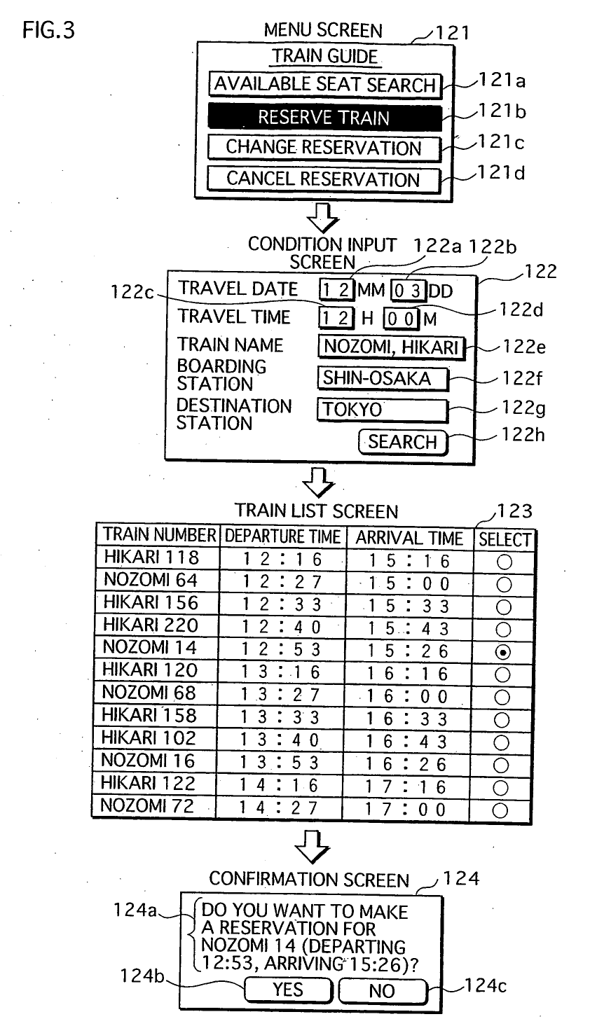

The display unit 105 displays various information under the control of the control unit 101. Examples of the information displayed by the display unit 105 are shown in FIG. 3.

The display unit 105 receives a menu screen 121, a condition input screen 122, a train list screen 123, and a confirmation screen 124, as shown as an example in FIG. 3, from the control unit 101, and displays the received menu screen 121, condition input screen 122, a train list screen 123, and confirmation screen 124.

The menu screen 121 includes a plurality of choices 121a, 121b, 121c, and 121d from which a selection is made by the user. Of the choices, choice 121b is display for making a reservation on a train. Reservation processing for making a reservation on a train is executed when the selection 121b is selected by the user.

The condition input screen 122 includes a plurality of input fields 122a, 122b, 122c, 122d, 122e, 122f, and 122g, and one operation button 122h. Here, the train search conditions are the travel date, the travel time (hour and minute), the train name, the boarding station, and the destination station. The input fields 122a and 122b are used for inputting the month and day of travel, respectively, and the input fields 122c and 122d are used for inputting the hour and minute of travel, respectively. The input fields 122e, 122f, and 122g are used for inputting the train name, the boarding station, and the destination station, respectively. Train search processing for a train that fulfills the search conditions is executed when the operation button 122h is operated by the user.

The train list screen 123 includes a plurality of pieces of train display information, each of which is composed of a train number, a departure time, an arrival time, and a selection button. The train number is a name and number identifying the train, the departure time is the time at which the train departs, and the arrival time is the time at which the train arrives. A train corresponding to a selection button is selected according to an operation of the selection button by the user.

The confirmation screen 124 includes a message 124a that indicates a prompt to the user to confirm the reservation, and operation buttons 124b and 124c. Confirmation information that indicates either acceptance or non-acceptance of the reservation, depending on which of the operation buttons 124b and 124c is operated by the user, is transmitted according to the operation of the operation button 124b or 124c.

(2) Input Unit 104

The input unit 104 receives various types of information and operation instructions according to user operations, and outputs the received information and operation instructions to the control unit 101.

While the menu screen 121 is being displayed by the display unit 105, the input unit 104 receives a selection of one of the choice 121a, the choice 121b, the choice 121c, and the choice 121d. When the choice 121b has been selected, the input unit 104 generates a reservation request indicating the start of train reservation processing, and outputs the generated reservation request to the control unit 101.

While the condition input screen 122 is being displayed by the display unit 105, the input unit 104 receives input of the travel date, travel time, train name, boarding station, and destination station according to user operation, and receives an operation of the operation button 122h. When the travel date, travel time, train name, boarding station, and destination station have been input and the operation button 122h is operated, the input unit 104 outputs train conditions made up of the travel date, travel time, train name, boarding station, and destination station to the control unit 101.

While the train list screen 123 is being displayed by the display unit 105, the input unit 104 receives a selection of one of the selection buttons according to user operation. On receiving the selection, the input unit 104 outputs a selection number corresponding to the button of which the selection was received to the control unit 101.

While the confirmation screen 124 is being displayed by the display unit 105, the input unit 104 receives selection of one of the operation buttons 124b and 124c according to user operation. On receiving the selection, the input unit 104 outputs confirmation information indicating either acceptance or non-acceptance, depending on for which of the operation buttons 124b and 124c the operation was received, to the control unit 101.

(3) Control Unit 101

<Reservation Processing>

The control unit 101 outputs the menu screen 121 to the display unit 105, and controls the display unit 105 to display the menu screen 121.

The control unit 101 receives condition input screen information (described later) that makes up the condition input screen, train list screen information (described later), and confirmation screen information (described later), and temporarily stores the received train list screen information internally. Furthermore, the control unit 101 generates the condition input screen 122, the train list screen 123, and the confirmation screen 124, with use of the received condition input screen information, train list screen information, and confirmation screen information, respectively, and outputs the generated condition input screen 122, train list screen 123, and confirmation screen 124 to the display unit 105.

Furthermore, the control unit 101 receives the reservation request, the train search conditions, and the confirmation information from the input unit 104. Here, the train search conditions are the travel date, the travel time, the train name, the boarding station and the destination station, and the confirmation information indicates either the user's acceptance of non-acceptance. Furthermore, the control unit 101 temporarily stores the received train search conditions internally. The control unit 101 then transmits the received reservation request, train search conditions, and confirmation information to the reservation center apparatus 300 via the communication unit 106 and the Internet 20:

Furthermore, the control unit 101 receives the selection number from the input unit 104, extracts the train number corresponding to the received selection number from the internally stored train list screen information, extracts the travel date, travel time, boarding station, and destination station from the temporarily stored train search conditions, and generates train reservation conditions made up of the extracted travel date, travel time, train number, boarding station, and destination station. The control unit 101 then transmits the generated train reservation conditions to the reservation center apparatus 300 via the communication unit 106 and the Internet 20.

<Authentication Processing>

During mutual authentication between the memory card 200 and the reservation center apparatus 300, the control unit 101 receives information from the reservation center apparatus 300 via the Internet 20 and the communication unit 106, and outputs the received information to the memory card 200 via the input/output unit 103. Furthermore, the control unit 101 receives information from the memory card 200 via the input/output unit 103, and outputs the received information to the reservation center apparatus 300 via the communication unit 106 and the Internet 20.

(4) Communication Unit 106

The communication unit 106 connects to an external apparatus via the Internet 20. The communication unit 106 transfers information between the external apparatus and the control unit 101.

Here, one example of the external apparatus is the reservation center apparatus 300.

(5) Input/Output Unit 103

The input/output unit 103 is connected to the memory card 200 by the memory card 200 being mounted in the personal computer 100. The input/output unit 103 transfers data between the memory card 200 and the control unit 101.

(6) Information Storage Unit 102

The information storage unit 102 has areas for storing various types of information.

1.3 Memory Card 200

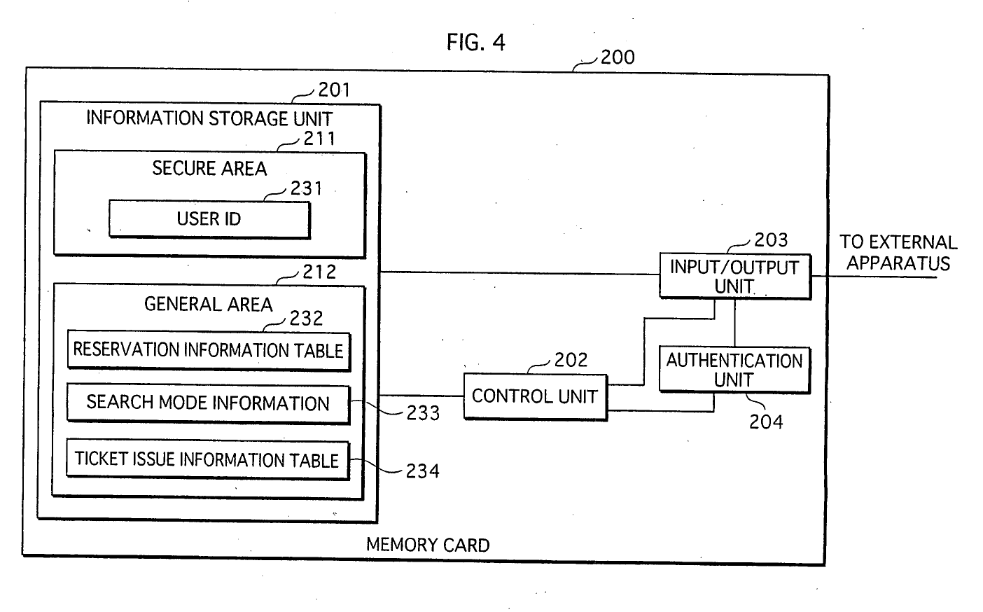

The memory card 200, as shown in FIG. 4, is composed of an information storage unit 201, a control unit 202, an input/output unit 203, and an authentication unit 204.

The memory card 200 is, specifically, a card-type computer system composed of a microprocessor, a ROM, a RAM, and the like. The RAM stores computer programs, and the memory card 200 achieves its functions by the microprocessor operating according to the computer programs.

(1) Information Storage Unit 201

The information storage unit 201, as shown in FIG. 4, is composed of a secure area 211 and a general area 212.

Permission to access the secure area 211 is given to an external apparatus in which the memory card 200 is mounted when mutual device authentication between the external device and the memory card 200 is successful. The secure area 211, as shown in FIG. 4, stores a user ID 231. The user ID 231 is identification information for identifying the user who possesses the memory card 200.

The general area 212 is freely accessible by the external apparatus in which the memory card 200 is mounted. The general area 212, as shown in FIG. 4, has an area from storing a reservation information table 232, search mode information 233, and a ticket issue information table 234.

<Reservation Information Table 232>

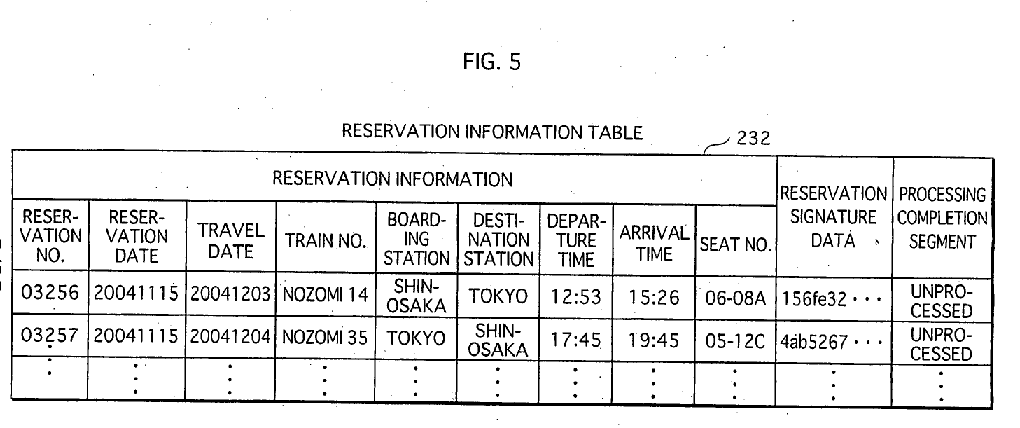

The reservation information table 232, as shown by the data structure shown in FIG. 5 as one example, is composed of a plurality of sets of information, each of which includes reservation information, reservation signature data, and a processing completion segment. Each set corresponds to one reservation.

The reservation information is composed of a reservation number, a reservation date, a travel date, a train number, a boarding station, a destination station, a departure time, an arrival time, and a seat number.

The reservation number is an identification number for identifying the reservation. The reservation date indicates the year, month and day on which the reservation was made. The travel date indicates the year, month and day of the train service for which the reservation has been made. The train number is a name and number identifying the train for which the reservation is made. The boarding station indicates the station at which the train for which the reservation has been made will be boarded, and the destination station indicates the station at which the train for which the reservation has been made will be alighted. The departure time indicates the time (hour and minute) at which the train departs from the station indicated by the boarding station, and the arrival time indicates the time (hour and minute) at which the train arrives at the station indicated by the destination station. The seat number indicates the number of the seat reserved in the train.

The reservation signature data is signature data generated by applying a digital signature SIG to the corresponding reservation information. The digital signature SIG is a digital signature algorithm that uses, as one example, ElGamal encryption on an elliptic curve. The security of the ElGamal encryption on the elliptic curve is based on a discrete logarithm problem on the elliptic curve.

The processing completion segment indicates whether or not ticket issue information, which is a ticket for the train, has been generated using the corresponding reservation information. When the reservation information has not yet been used, the processing completion segment indicates “unprocessed”, and when reservation information has already been used to generate ticket issue information, the processing completion segment indicates “processed”.

<Search Mode Information 233>

The search mode information 233 is set to either present location search mode or non-search mode. Present location search mode indicates a state of performing a reservation change search, and non-search mode indicates a state of not performing a reservation change search.

<Ticket Issue Information Table 234>

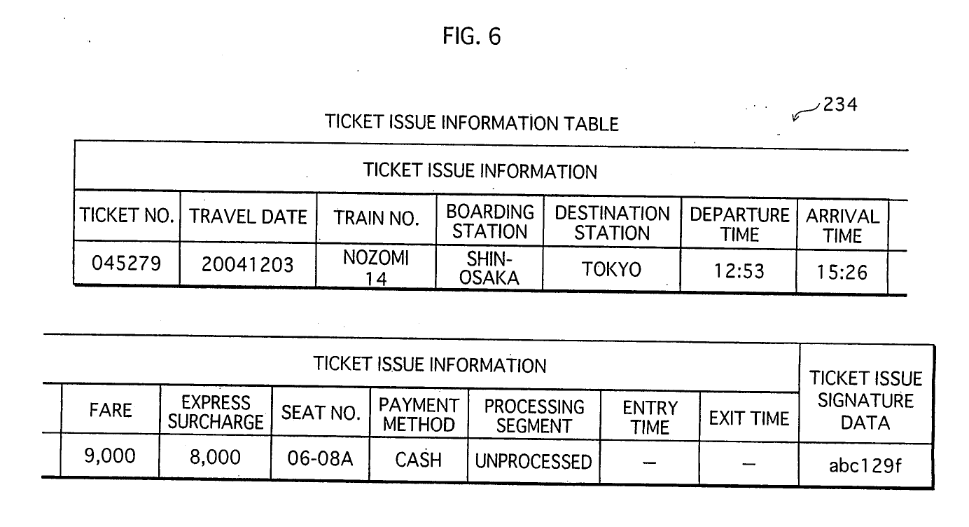

The ticket issue information table 234, as shown by the data structure shown in FIG. 6 as one example, is composed of ticket issue information and ticket issue signature information.

The ticket issue information is composed of a ticket issue number, a travel date, a train number, a boarding station, a destination station, a departure time, an arrival time, a fare, an express surcharge, a seat number, a payment method, a processing segment, an entry time, and an exit time. The ticket issue information corresponds to a train ticket.

The ticket issue number is identification information identifying the ticket information as the train ticket. The travel date indicates the date (year, month, day) of service of the train. The train number indicates an identification number identifying the train. The boarding station indicates the name of the station the train for which the reservation has been made will be boarded, and the destination station indicates the station at which the train for which the reservation has been made will be alighted. The departure time indicates the time (hour and minute) at which the train departs from the station indicated by the boarding station, and the arrival time indicates the time (hour and minute) at which the train arrives at the station indicated by the destination station.

The fare indicates the basic fare for traveling from the boarding station to the destination station, and the express surcharge indicates a surcharge when the train is an express train. The seat number indicates the number of the seat reserved in the train.

The payment method indicates the method used to purchase the ticket, examples of the payment method being cash, credit card, and electronic money. The processing segment indicates the state of usage of the ticket, “unprocessed” meaning that the ticket has not been used, “boarded” meaning that the user has entered the station of boarding station, and “alighted” meaning that the user has left the station of the destination station. The entrance time and exit time indicate the date (year, month, day) that the user entered the boarding station and left the destination station, respectively. The entrance time and exit time are recorded at the time of entering the station of boarding station and exiting the station of the destination station, respectively, and are blank at the time of generation of the ticket issue information.

The ticket issue signature data is signature data generated by applying a digital signature SIG to the corresponding ticket issue information.

(2) Authentication Unit 204

When the memory card 200 is mounted in or connected to an external apparatus, the authentication unit 204 performs authentication to confirm whether or not the external apparatus is legitimate. Furthermore, the authentication unit 204 receives authentication from the external apparatus. Details of authentication are described later.

(3) Control Unit 202

When mutual device authentication between an authentication unit 307 (described later) of the reservation center apparatus 300 and the authentication unit 204 succeeds, the control unit 202 reads the user ID from the secure area 211, and transmits the user ID to the reservation center apparatus 300 via the personal computer 100 and the Internet 20.

Furthermore, the control unit 202 judges which of the present location search mode and the non-search mode is indicated by the search mode information 233 stored in the general area 212. When the search mode information 233 indicates present location search mode, the control unit 202 performs a reservation change search (described later), and when the search mode information 233 indicates non-search mode, the control does not perform a reservation change search.

<Reservation Change Search>

On judging the search mode information 233 to indicate present location search mode, the control unit 202 compares, for each reservation information included in the reservation information table 232, the departure time included in the reservation information with the present time, and judges whether the present time is 24 hours, 12 hours, 6 hours, 3 hours, 2 hours, 1 hour 45 minutes, 1 hour 30 minutes, 1 hour 15 minutes, 1 hour, 45 minutes, or 30 minutes before the departure time. When the present time is none of these amounts of time before the departure time, the control unit 202 performs no particular processing. When the present time is any one of these amounts before the departure time, the control unit 202 outputs a location obtain request to the mobile telephone 400 via the input/output unit 203. The location obtain request is a request to obtain the present location (latitude and longitude) of the mobile telephone 400 in which the memory card 200 is mounted.

The control unit 202 then obtains the present location (latitude and longitude) from the mobile telephone 400 via the input/output unit 203, and controls the authentication unit 204 so as to perform mutual device authentication with the timetable server apparatus 500.

When device authentication with the timetable server apparatus 500 succeeds, the control unit 202 generates a distance obtain request requesting obtaining of the distance between the present location (latitude and longitude) and the boarding station. The control unit 202 extracts the boarding station from the reservation information, and transmits the generated distance obtain request, the received present location, and the extracted boarding station to the timetable server apparatus 500 via the mobile telephone 400, the radio base station 11, the mobile telephone network 10, and the Internet 20.

Next, the control unit 202 receives the distance between the present location an the boarding station from the timetable server apparatus 500 via the Internet 20, the mobile telephone network 10, a radio base station 11, and the mobile telephone 400.

When the present time is judged to be 24 hours before the departure time in the aforementioned judgment of the departure time and the present time, the control unit 202 judges whether or not the received distance is 1000 km or greater. When the received distance is judged to be less than 1000 km, the control unit 202 ends the reservation change search. When the received distance is judged to be 1000 km or greater, the control unit 202 continues the reservation change search.

Similarly, when the present time is judged to be 12 hours, 6 hours, or 3 hours before the departure time, the control unit 202 judges whether or not the received distance is 600 km or greater, 100 km or greater, or 50 km or greater, respectively, and either ends or continues the reservation change search, depending on the result of the judgment.

Similarly, when the present time is judged to be 2 hours, 1 hour 45 minutes, 1 hour 30 minutes, 1 hour 15 minutes, 1 hour, 45 minutes, or 30 minutes before the departure time, the control unit 202 judges whether or not the received distance is 10 km or greater, and either ends or continues the reservation change search, depending on the result of the judgment.

When continuing the search, the control unit 202 generates an expected arrival time obtain request indicating obtaining of the expected arrival time of the user at the station of boarding station, and transmits the generated predicted arrival time obtain request, the present location, and the boarding station to the timetable server apparatus 500 via the input/output unit 203, the mobile telephone 400, the radio base station 11, the mobile telephone network 10, and the Internet 20.

The control unit 202 then receives the expected arrival time from the timetable server apparatus 500 via the Internet 20, the mobile telephone network 10, the radio base station 11, and the mobile telephone 400.

Next, the control unit 202 compares the departure time included in the reservation information with an expected time obtained by adding a margin value of 5 minutes to the received expected arrival time, and when the departure time is greater than or equal to the expected time, ends the reservation change search. When the departure time is not greater than or equal to the expected time, the control unit 202 continues the reservation change search. Note that the margin value is not limited to being 5 minutes. As other examples, the margin value may be 10 minutes, 15 minutes or 20 minutes. Alternatively, it is possible to not use a margin value.

Since the departure time is nearing, the control unit 202 generates an update message indicating to the user to confirm whether or not to update the reservation, and outputs the generated update message to the mobile telephone 400 to the input/output unit 203.

The control unit 202 then receives an update instruction or a non-update instruction from the mobile telephone 400 via the input/output unit 203, as confirmation information. On receiving the non-update instruction, the control unit 202 ends the reservation change search. On receiving the update instruction, the control unit 202 performs the following processing to update the reservation.

<Reservation Update Processing>

On receiving the update instruction, the control unit 202 controls the authentication unit 204 so as to perform mutual device authentication with reservation center apparatus 300 via the input/output unit 203, the mobile 400, the radio base station 11, the mobile telephone network 10, and the Internet 20.

When authentication succeeds, the control unit 202 generates train reservation change information. The train reservation change information is composed of a train reservation change instruction instructing change of the reservation, a reservation number identifying the reservation information that is to be changed, and the corresponding reservation signature data. The control unit 202 transmits the train reservation change information to the reservation center apparatus 300 via the input/output unit 203, the mobile telephone 400, the radio base station 11, the mobile telephone network 10, and the Internet 20.

The control unit 202 deletes the reservation information and reservation signature data that are being changed (the old reservation information and the old reservation signature data) from the reservation information table 232.

(4) Input/Output Unit 203

When the memory card 200 is mounted in an external apparatus, the input/output unit 203 transfers information to an from the external apparatus as follows.

When the memory card 200 is mounted in the personal computer 100, the input/output unit 203 receives reservation signature data and reservation information from the reservation center apparatus 300 via the Internet 20, and the personal computer 100, and writes the received reservation signature data and reservation information to the general area 212.

When the memory card 200 is mounted in the mobile telephone 400, the input/output unit 203 receives an instruction indicating setting of the search mode information 233 to either present location search mode or non-search mode, and sets the search mode information 233 to either present location search mode or non-search mode, depending on the content of the instruction. Furthermore, the input/output unit 203 receives reservation signature data and reservation information from the reservation center apparatus 300 via the Internet 20, the mobile telephone network 10, and the mobile telephone 400, and writes the received reservation signature data and reservation information to the general area 212.

When the memory card 200 is mounted in the ticket vending machine 600, the input/output unit 203 receives a reservation information request requesting reservation information from the ticket vending machine 600. On receiving the reservation information request, the input/output unit 203 reads the reservation information table 232 from the general area 212, and outputs the read reservation information table 232 to ticket vending machine 600. Furthermore, the input/output unit 203 receives ticket issue information and ticket issue signature data from the ticket vending machine 600, and writes the received ticket issue information and ticket issue signature data to the ticket issue information table 234. At this time, the overwrites the processing completion segment included in the input/output unit 230 reservation information corresponding to the received ticket issue information to “complete”.

1.4 Reservation Center Apparatus 300

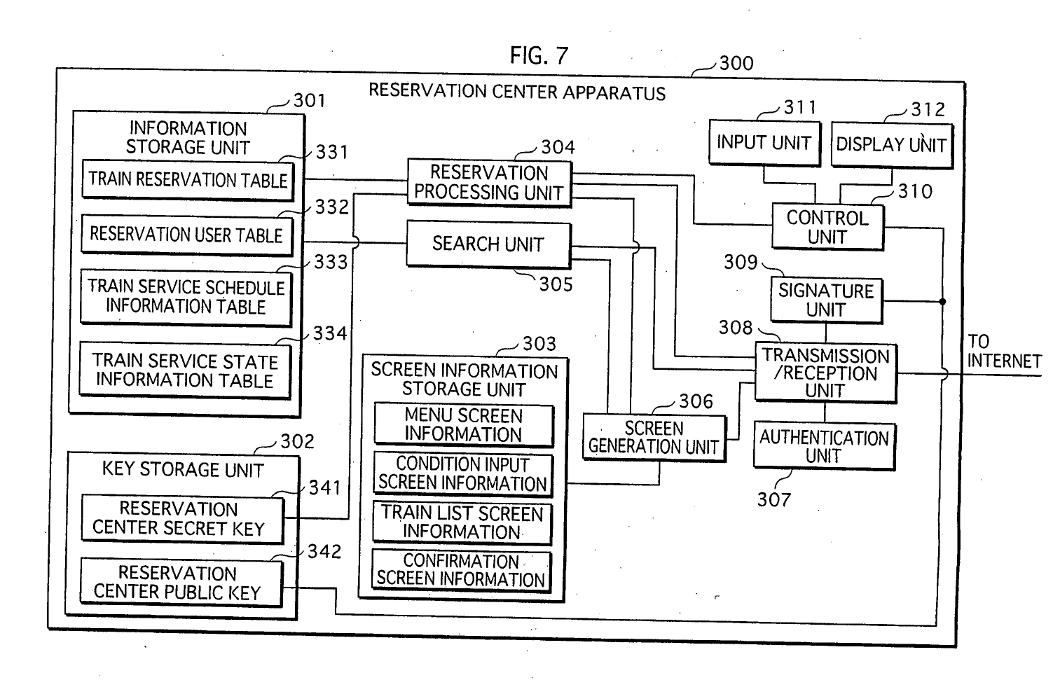

The reservation center apparatus 300, as shown in FIG. 7, is composed of an information storage unit 301, a key storage unit 302, a screen information storage unit 303, a reservation processing unit 304, a search unit 305, a screen generation unit 306, an authentication unit 307, a transmission/reception unit 308, a signature unit 309, a control unit 310, an input unit 311, and a display unit 312.

The reservation center apparatus 300 is a computer system similar to the personal computer 100, and is composed, specifically, of a microprocessor, a ROM, a RAM, a hard disk unit, a keyboard, a mouse, a LAN connection unit, and the like. Computer programs are stored in the RAM or the hard disk unit, and the reservation center apparatus 300 achieves its functions by the microprocessor operating according to the computer programs.

(1) Information Storage Unit 301

The information storage unit 301 has an area for storing a train reservation table 331, a reservation user table 332, a train service schedule information table 333, and a train service state information table 334.

<Train Reservation Table 331>

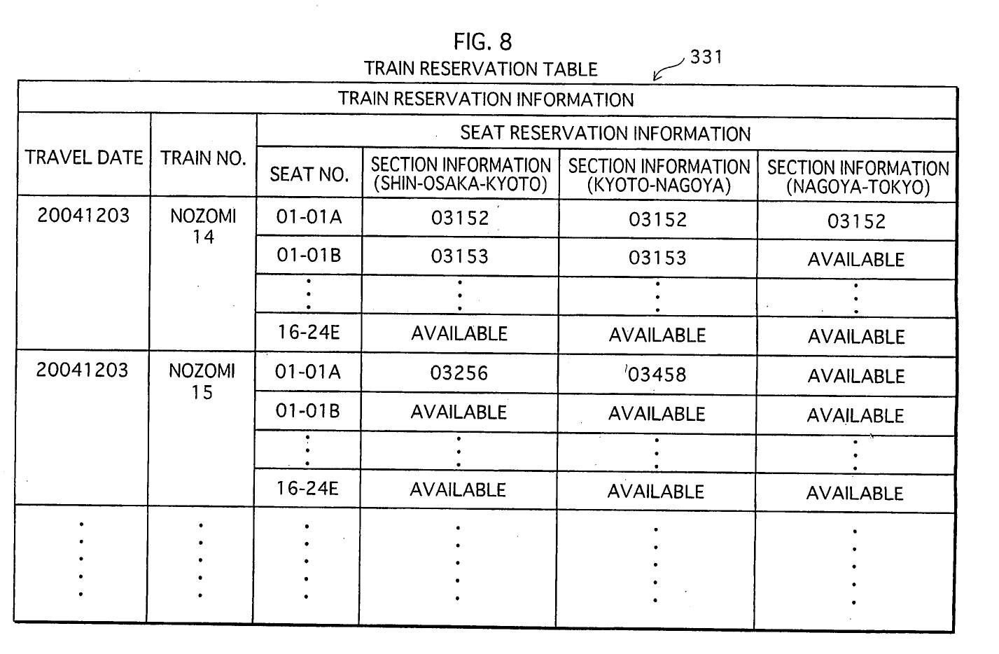

The train reservation table 331, as shown in FIG. 8, has an area for storing a plurality of pieces of train reservation information. Each train reservation information corresponds to one train, and indicates the state of reservations for the train.

Note that the train reservation table 331 includes train reservation information about all train services for six months from the present day (the day on which processing to the train reservation table 331 is being performed). Every day after processing for the day has ended, for example at 12:00 am the next day, train reservation for train services for six months from the present day is additionally written to the train reservation table 331, and the train reservation information corresponding to the services for the preceding day is deleted.

Each train reservation information, as shown in FIG. 8, includes a travel date, a train number, and a plurality of pieces of seat reservation information. The travel date indicates the date (year, month, day) of one train service. The train number is an identification number identifying the train. Each piece of seat reservation information includes a seat number and a plurality of pieces of section information.

The seat number is an identification number identifying one seat on the train, and is composed of a number indicating one carriage in the train and a number indicating the seat in the carriage.

Each piece of section information indicates whether or not the seat is reserved between each set of neighboring stations from the station from which the train departs, through to the station of origin of the train. When the seat is reserved, the section information includes the reservation number. When the seat is not reserved, the section information indicates “available”. The reservation number is as described earlier.

In the example of the train reservation table 331 in FIG. 8, the seat reservation information has three pieces of section information, the first section information indicating whether or not the seat is reserved between Shin-Osaka and Kyoto, the second section information indicating whether or not the seat is reserved between Kyoto and Nagoya, and the third section information indicating whether or not the seat is reserved between Nagoya and Tokyo.

<Reservation User Table 332>

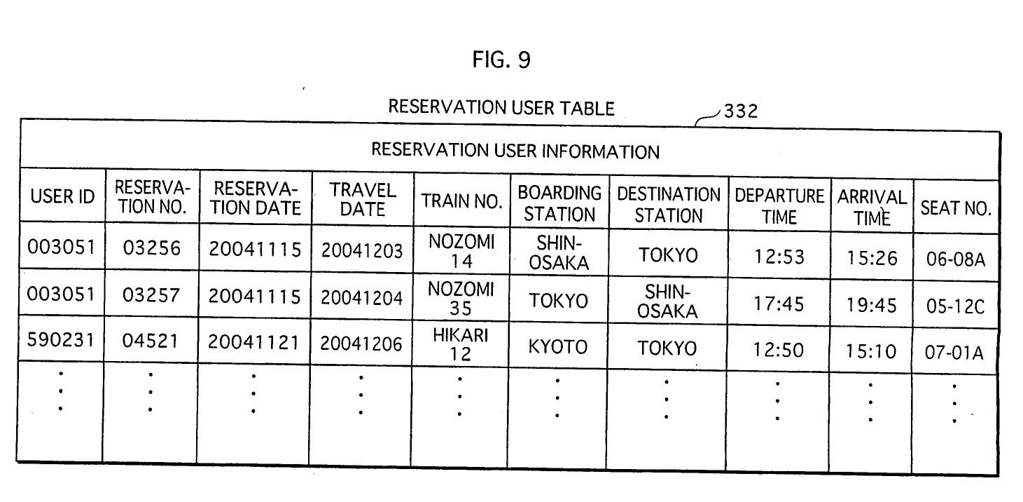

As shown as one example of data structure in FIG. 9, the reservation user table 332 has an area for storing a plurality of pieces of reservation user information.

Each piece of reservation user information is composed of a user ID, a reservation number, a reservation date, a travel date, a train number, a boarding station, a destination station, a departure time, an arrival time, and a seat number, and corresponds to one reservation by a user.

The user ID is identification information identifying a user.

The reservation number, the travel date, the train number, the boarding station, the destination station, the departure time, the arrival time, and the seat number are identical to the reservation number, the travel date, the train number, the boarding station, the destination station, the departure time, the arrival time, and the seat number in the reservation information in FIG. 5, and therefore a description thereof is omitted here.

<Train Service Schedule Information Table 333>

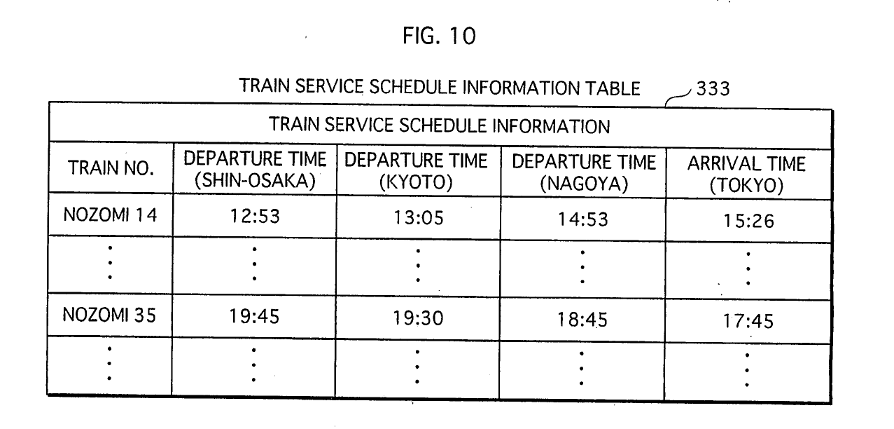

The train service schedule information table 333, as shown as one example of data structure in FIG. 10, includes an area for storing a plurality of pieces of train service schedule information.

Each piece of train service schedule information corresponds to one train, and indicates the scheduled train service. Each train service schedule information includes a train number, a plurality of departure times, and an arrival time.

The train number is an identification number identifying the train. Each departure time indicates the time at which the train is scheduled to depart one of the stations from the boarding station and stations en route to the final destination station. The arrival time indicates the time at which the train in scheduled to arrive at the final destination station.

In the train service schedule table 333 in FIG. 10, each piece of train service schedule information includes, as an example, three departure times. The first departure time is the scheduled time of departure from Shin-Osaka, which is the boarding station. The second departure time is the scheduled time of departure from Kyoto, which is a station en route, and the third departure time is the scheduled time of departure from Nagoya, which is also a station en the route. The arrival time is the scheduled arrival time at Tokyo, which is station of the final destination of the train.

<Train Service State Information Table 334>

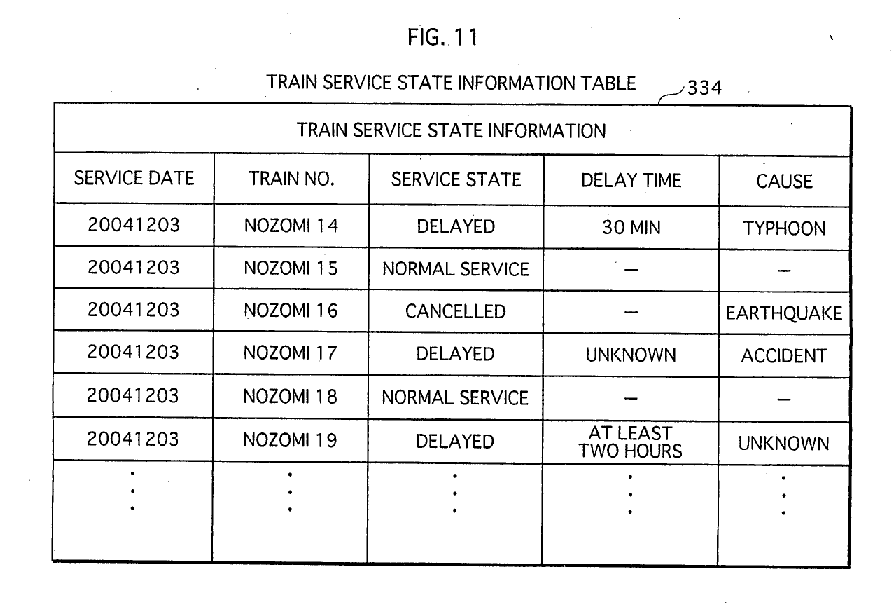

The train service state information table 334, as one example of data structure shown in FIG. 11, has an area for storing a plurality of pieces of train service station information.

Each piece of train service state information corresponds to one train, and indicates the actual state of the train service. Each piece of train service state information is composed of a service date, a train number, a service state, and a delay time, and a cause.

The service date is the date (year, month, day) of the train service. The train number is an identification number identifying the train. The service state indicates the state of the service, and, specifically, indicates a state such as the train service operating as normal, a delay in the train service, or the train service having been cancelled. The delay time indicates the length of delay in cases in which the service state indicates a delay. The cause indicates the cause in cases in which the state of the service is a state other than normal.

(2) Key Storage Unit 302

The key storage unit 302 is a storage unit to which access is permitted only from a particular device. Specifically, the particular device is the reservation processing unit 304.

The key storage unit 302 stores a reservation center secret key and a reservation center public key. The reservation center secret key is a secret key generated according to a public key generation method that uses encryption on an elliptic curve. The security of the encryption on the elliptic curve is based on a discrete logarithm problem on the elliptic curve. The reservation center public key is generated based on the reservation center secret key according to the public key generation method.

(3) Screen Information Storage Unit 303

The screen information storage unit 303 stores menu screen information, condition input screen information, train list screen information, and confirmation screen information.

The menu screen information, the condition input screen information, the train list screen information, and the confirmation screen information are each used as a basis for generating a screen displayed by the personal computer 100, and are written in HTML (hypertext markup language).

The menu screen information, the condition input screen information, the train list screen information, and the confirmation screen information are used for generating the menu screen 121, the condition input screen 122, the train list screen 123, and the confirmation screen 124 shown in FIG. 3.

(4) Reservation Processing Unit 304

The reservation processing unit 304 receives train reservation conditions including a travel date, a travel time, a train number, a boarding station, and a destination station. On receiving the train reservation conditions, the reservation processing unit 304 checks whether or not seat reservation information that meets the received train reservation conditions, and that has indicates available, exists in the train reservation table 331. Specifically, the reservation processing unit 304 checks in the following manner.

The reservation processing unit 304 extracts all train reservation information (one or more pieces) that fulfills all of the following conditions 1 to 4, from the train reservation table 331.

Condition 1: Train reservation information that includes a travel date identical to the travel date included in the received train reservation conditions.

Condition 2: Train reservation information that includes a train number identical to the train number included in the received train reservation conditions.

Condition 3: Train reservation information that includes a departure time equal to or later than the travel time included in the received train reservation conditions, from the boarding station included in the received train reservation conditions.

Here, the departure time from the station included in the received train reservation conditions is obtained from the train service schedule information table 333.

Condition 4: Train reservation information in which all section information corresponding to the route from the boarding station to the destination station indicates “available”.

Having extracted one or more pieces of train reservation information in this way, the reservation processing unit 304 judges that seat reservation information that fulfills the received train reservation conditions exists in the train reservation table 331 as available. When train reservation information is not extracted, the reservation processing unit 304 judges that such seat reservation information does not exist as available.

When section information that satisfies the train reservation conditions does not exit, the reservation processing unit 304 outputs non-existence information indicating that such information does not exist, to the control unit 310.

When a plurality of pieces of section information that fulfill the received train reservation conditions exist as available in the train reservation table 331, the reservation processing unit 304 selects on of the pieces. When one piece of section information that fulfills the received train reservation conditions exist as available in the train reservation table 331, the reservation processing unit 304 selects the piece. The reservation processing unit 304 then locks (exclusively controls) the selected section information in the train reservation table 331.

Next, the reservation processing unit 304 reads the train service schedule information that includes the train number corresponding to the selected section information from the train service schedule information table 333, reads the train reservation information that includes the selected section information from the train reservation table 331, and outputs the read train service schedule information and train reservation information to the screen generation unit 306.

Furthermore, under the control of the control unit 310, the reservation processing unit 304 generates reservation information composed of a reservation number, a reservation date, a travel date, a train number, a boarding station, a destination station, a departure time, an arrival time, and a seat number. Here, the reservation number is a number uniquely assigned to the reservation information. The reservation date is the date on which the reservation processing is performed. The travel date, the train number and the seat number are the travel date, train number, and seat number, respectively, included in the train reservation information that includes the selected section information. The boarding station and destination station are station names specified in the selected section information. The departure time and arrival time correspond to the train number obtained from the train service schedule information table 333, and are the departure time and arrival time from/at the boarding station and the destination station.

The reservation processing unit 304 receives reservation signature data from the signature unit 309, and transmits the received reservation signature data and the generated reservation information to the memory card 200 via the transmission/reception unit 308, the Internet 20 and the personal computer 100, or via the transmission/reception unit 308, the Internet 20, the mobile telephone network 10, the radio base station 11, and the mobile telephone 400.

When mutual device authentication with the memory card 200 is successful, the reservation processing unit 304 receives a user ID from the control unit 310.

Furthermore, the reservation processing unit 304 writes the reservation number to the locked section information, releases the lock, adds the user ID to the reservation information, thereby generating reservation user information, and writes the generated reservation user information to the reservation user table 332.

When device authentication with the memory card 200 fails, the reservation processing unit 304 releases the lock on the section information, and ends the processing.

When a reservation is to be changed, the reservation processing unit 304 deletes the user information being updated from the reservation user table 332, and overwrites the section information that is being updated to “available” in the train reservation table 331.

(5) Search Unit 305

The search unit 305 receives train search conditions composed of a travel date, a travel time, a train name, a boarding station, and a destination station from the control unit 310.

Next, the search unit 305 generates train list screen information that includes information of a train or trains that fulfill the received train search conditions, with use of the train reservation table 331 and the train service schedule information table 333. Specifically, the search unit 305 generates the train list screen information as follows.

(i) The search unit 305 extracts all pieces of train reservation information that fulfill the following conditions 1 to 4 from the train reservation table.

Condition 1: Train reservation information that includes a travel date identical to the travel date included in the received train search conditions.

Condition 2: Train reservation information that includes a train name identical to the train name included in the received train search conditions.

Condition 3: Train reservation information that includes a departure time equal to or later than the travel time included in the received train reservation conditions, from the boarding station included in the received train reservation conditions.

Here, the departure time from the station included in the received train reservation conditions is obtained from the train service schedule information table 333.

Condition 4: Train reservation information in which all section information corresponding to the route from the boarding station to the destination station indicates “available”.

(ii) The search unit 305 extracts the train number from each extracted piece of train reservation information.

(iii) The search unit 305 extracts the departure time from and arrival time at the boarding station and destination station of each train identified by the extracted train numbers.

(iv) The search unit 305 generates train list screen information that includes the set or sets of departure time and arrival time.

Next, the search unit 305 transmits the generated train list screen information to the to the personal computer 100 via the transmission/reception unit 308 and the Internet 20, or to the mobile telephone 400 via the transmission/reception unit 308, the Internet 20, the mobile telephone network 10, and the radio base station 11.

Furthermore, when a reservation is being changed, the search unit 305, under the control of the control unit 310, searches for trains in the manner described above, using the reservation information.

(6) Screen Generation Unit 306

The screen generation unit 306 receives a reservation request from the control unit 310. On receiving the reservation request, the screen generation unit 306 reads the condition input screen information from the screen information storage unit 303, and transmits the read condition input screen information to the personal computer 100 via the transmission/reception unit 308 and the Internet 20.

Furthermore, the screen generation unit 306 receives train service schedule information and train reservation information from the reservation processing unit 304. On receiving the train service schedule information and train reservation information, the screen generation unit 306 reads the confirmation screen information from the screen information storage unit 303, and, with use of the read confirmation screen information and the received train service schedule information and train reservation information, generates confirmation screen information for displaying the confirmation screen 124 shown in FIG. 3. The screen generation unit 306 then transmits the generated confirmation screen information to the personal computer 100 via the transmission/reception unit 308 and the Internet 20.

(7) Authentication Unit 307

Under the control of the control unit 310, the authentication unit 307 performs authentication with the memory card 200 to determine whether the memory card 200 is legitimate, via the transmission/reception unit 308, the Internet 20, and the personal computer 100, or via the transmission/reception unit 308, the Internet 20, the mobile telephone network 10, the radio base station 11 and the mobile telephone 400. The authentication unit 307 also receives authentication from the memory card 200. The authentication is described in detail later.

(8) Transmission/Reception Unit 308

The transmission/reception unit 308 connects to external apparatuses via the Internet 20, and transmits and receives data to and from the external apparatuses.

(9) Signature Unit 309

Under the control of the control unit 310, the signature unit 309 reads the reservation center secret key from the key storage unit 302, receives the reservation information from the reservation processing unit 304, applies a digital signature SIG to the received reservation information with use of the read reservation center secret key, thereby generating reservation signature data, and outputs the generated reservation signature data to the reservation processing unit 304.

(10) Control Unit 310

<Operations for Reservation>

The control unit 310 receives a reservation request from the personal computer 100 via the Internet 20 and the transmission/reception unit 308. On receiving the reservation request, the control unit 310 outputs the reservation request to the screen generation unit 306.

Furthermore, the control unit 310 receives train search conditions made up of a travel date, a travel time, a train name, a boarding station, and a destination station, from the personal computer 100 via the Internet 20 and the transmission/reception unit 308, and outputs the received train search conditions to the search unit 305.

Furthermore, the control unit 310 receives train reservation conditions made up of a travel date, travel time, a train number, a boarding station, and a destination station, from the personal computer 100 via the Internet 20 and the transmission/reception unit 308, and outputs the received train reservation conditions to the reservation processing unit 304.

The control unit 310 receives non-existence information indicating the seat reservation information that fulfills the train reservation conditions received from the reservation processing unit 304 does not exist in the train reservation table 331. On receiving the non-existence-information, the control unit 310 controls the search unit 305 so as to re-perform the search and transmit train list screen information to the personal computer 100.

Furthermore, the control unit 310 receives confirmation information indicating the user's acceptance or non-acceptance of the aforementioned confirmation, from the personal computer 100 via the Internet 20 and the transmission/reception unit 308, and when the received confirmation information indicates non-acceptance, the control unit 310 ends the processing. When the received confirmation information indicates acceptance, the control unit 310 controls the reservation processing unit 304 so as to generate reservation information.

When mutual device authentication with the memory card 200 is successful, the control unit 310 receives a user ID from the memory card 200 via the personal computer 100 and the Internet 20, and outputs the received user ID to the reservation processing unit 304.

<Operations for Reservation Changing>

The control unit 310 receives a request for device authentication from the memory card 200 via the mobile telephone 400, the radio base station 11, the mobile telephone network 10, and the Internet 20. On receiving the request, the control unit 310 controls the authentication unit 307 so as to perform mutual device authentication with the memory card 200.

When device authentication with the memory card 200 succeeds, the control unit 310 receives train reservation change information composed of a train reservation change instruction, a reservation number, and reservation signature data, from the memory card 200 via the mobile telephone 400, the radio base station 11, the mobile telephone network-10 and the Internet 20. On receiving the train reservation change information, the control unit 310 controls the signature unit 309 so as to verify the reservation signature data. When verification is successful, the control unit 310 reads reservation user information corresponding to the received reservation number (included in the train reservation change information) from the reservation user table 332, extracts the travel date and the train number from the read reservation user information, and reads train service state information that includes the extracted travel date and train number from the train service state information table 334. Next, the control unit 310 extracts the service state from the read train service state information, and judges which of “normal service”, “delayed”, and “cancelled” is indicated by the read train service state information.

(a) “Cancelled”

When the service state is “cancelled”, the control unit 310 transmits a message indicating that the service is cancelled, to the memory card 200 via the transmission/reception unit 308, the Internet 20, the mobile telephone network 10, the radio base station 11, and the mobile telephone 400.

Next, the control unit 310 receives, as confirmation information, a reservation change instruction indicating that reservation is to be changed, from the memory card 200 via the mobile telephone 400, the radio base station 11, a mobile telephone 10, the Internet 20, and the transmission/reception unit 308. The control unit 310 the continues reservation change processing.

(b) “Delayed”

When the service state is judged to be “delayed”, the control unit 310 transmits a message indicating that the service is delayed, to the memory card 200 via the transmission/reception unit 308, the Internet 20, the mobile telephone network 10, the radio base station 11, and the mobile telephone 400.

Next, the control unit 310 receives either a reservation change instruction indicating that the reservation is to be changed or a reservation non-change instruction indicating that the reservation is not to be changed. Here, on receiving the reservation non-change instruction, the control unit 310 ends processing without performing the subsequent reservation change processing. On receiving the reservation change instruction, the control unit 310 continues the reservation change processing.

(c) “Normal Service”

When the service state is judged to be (i) delayed, (ii) cancelled and a reservation change instruction indicating that the reservation is to be changed is received from the memory card 200, or (iii) delayed and a reservation change instruction is received from the memory card 200, the control unit 310, in the manner described above, controls the search unit 305 so as to search for trains based on the reservation user information, and controls the reservation processing unit 304 so as to check for an available seat, generate reservation information, delete the reservation user information being updated, and generate new reservation user information, generate reservation signature data, and transmit the reservation information and the reservation signature data.

(11) Input Unit 311 and Display Unit 312

The input unit 311 receives operations from an operator of the reservation center apparatus 300, and outputs information and instructions corresponding to the received operations to the control unit 310.

The display unit 312 displays various types of information under the control of the control unit 310.

1.5 Mobile Telephone 400

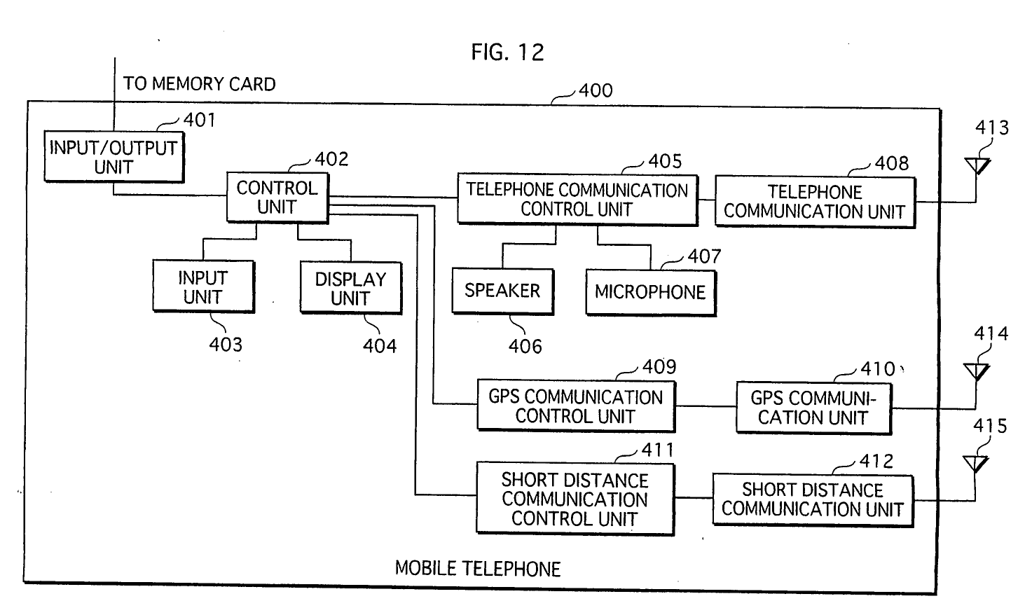

The mobile telephone 400, as shown in FIG. 12, is composed of an input/output unit 401, a control unit 402, an input unit 403, a display unit 404, a telephone communication control unit 405, a telephone communication unit 408, a speaker 406 that outputs audio, a microphone 407 that receives input of audio, a GPS communication control unit 409, a GPS communication unit 410, a short distance communication control unit 411, a short distance communication unit 412, an antenna 413, an antenna 414, and an antenna 415.

The mobile telephone 400 is, specifically, a computer system composed of a microprocessor, a signal processor, a ROM, a RAM, and so on. The mobile telephone 400 achieves part of its functions by the microprocessor and the signal processor operating according to computer programs stored in the mobile telephone 400.

(1) Antenna 413, Telephone Communication Unit 408, and Telephone Communication Control Unit 405

The antenna 413, the telephone communication unit 408, and the telephone communication control unit 405 perform transmission/reception of audio and information with an apparatus to which the mobile telephone 400 is connected via the radio base station 11 and the mobile telephone network 10.

The telephone communication unit 408 includes a reception unit and a transmission unit. The reception unit is composed of a high-frequency amplifier, a reception mixer, an IF amplifier, a demodulator, and so on, and has a function of amplifying and demodulating a signal received by the antenna 413. The transmission unit is composed of a transmission power amplifier, a transmission mixer, a modulator, and so on, and has a function of modulating a high frequency signal according to a baseband signal, converting the high frequency signal into a radio frequency, amplifying the signal, and having the antenna 413 output the signal. The telephone communication control unit 405 includes a baseband unit, and performs processing of various types of signals input from and output to the telephone communication unit.

(2) GPS Communication Control Unit 409, GPS Communication Unit 410, Antenna 414

Under the control of the control unit 402, the antenna 414 and the GPS communication unit 410 receive range finding signals transmitted from four GPS satellites 31, 32, 33 etc., according to microwaves of a 1.6 GHz band, and amplify and demodulate the signals. Under the control of the control unit 402, the GPS communication control unit 409 calculates the present location (latitude and longitude) of the mobile telephone 400 using the received range finding signals, and outputs the calculated present location to the control unit 402.

(3) Short Distance Communication Control Unit 411, Short Distance Communication Unit 412, Antenna 415

The antenna 415, the short distance communication unit 412, and the short distance communication control unit 411 perform radio transmission and reception of information to and from the automated ticket inspection machines 700, 751, and 752 using a frequency band of 2.4 GHz.

The short distance communication unit 412 includes a transmission/reception unit that receives and transmits signals via the antenna 415, and a modulation/demodulation unit that modulates and demodulates signals. The short distance communication control unit 411 processes various types of signals input by and output to the short distance communication unit 412. In addition, the short distance communication control unit 411 establishes a communication channel for short distance radio communication between the automated ticket inspection machine 700 and the short distance communication control unit 411, and subsequently communicates via the established communication channel.

(4) Input/Output Unit 401

The input/output unit 401 performs transmission and reception of information between the memory card 200 and the control unit 402 when the memory card 200 is mounted in the mobile telephone 400.

(5) Display Unit 404

The control unit 404 displays various information under the control of the control unit 402.

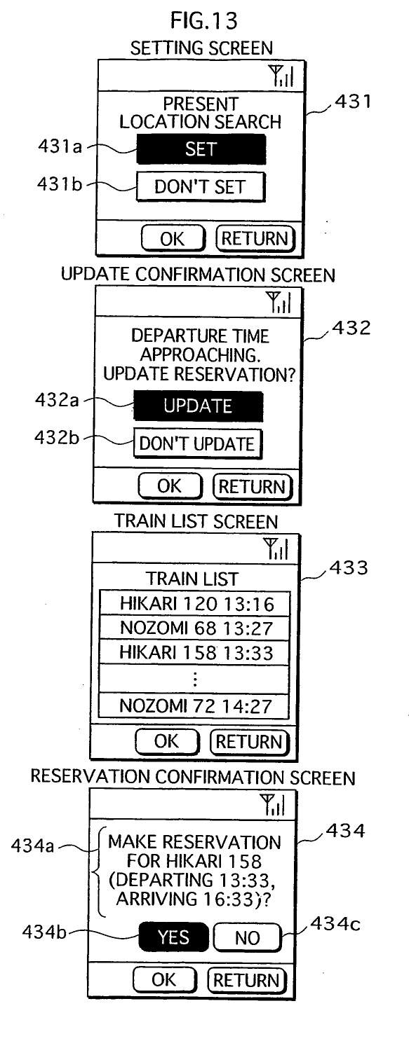

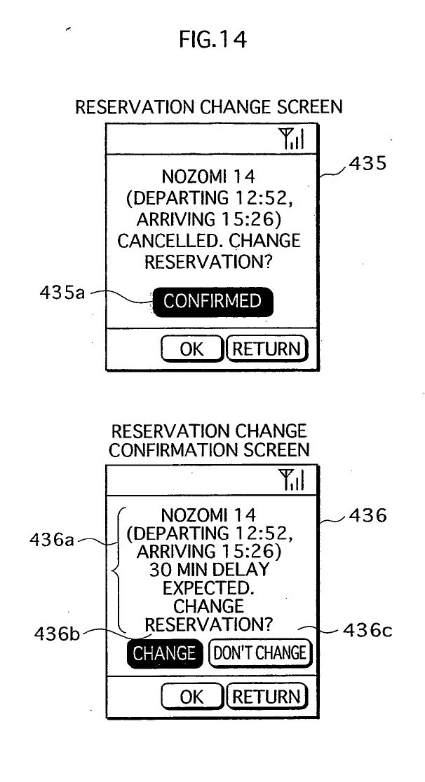

Examples of the screen displayed by the display unit 404 are a setting screen 431, an update confirmation screen 432, a train list screen 433, a reservation confirmation screen 434, a reservation change screen 435, and a reservation change confirmation screen 436 shown in FIG. 13 and FIG. 14.

The setting screen 431 is used for setting the search mode information described earlier 233, and includes operation buttons 431a and 431b. The operation button 431a is operated by the user to set present location search mode, and the operation button 431b is operated by the user to set non-search mode.

The update confirmation screen 432 is for inquiring to the user for a judgment of whether or not to update a reservation, and includes operation buttons 432a and 432b. The operation button 432a is operated by the user to confirm that he or she wishes to update the reservation, and the operation button 432b is operated to confirm that he or she wishes not to update the reservation.

The train list screen is for displaying a list of trains that may be used by the user if the reservation is updated, and includes a plurality of sets of information, each consisting of a train number and a departure time.

The reservation confirmation screen 434 is for inquiring to the user for a judgment of whether or not to make a reservation for the train selected by the user, and includes a display 434a of the train number, departure time and arrival time of the train selected by the user, and operation buttons 434b and 434c. The operation button 434b is used to confirm that the user wishes to make a reservation for the train indicated by the displayed train number, departure time and arrival time, and the operation button 434c is for confirming that the user wishes not to make a reservation for the train.

The reservation change screen 435 is used for informing the user that the reservation will be changed when the train for which the user has a reservation has been cancelled, and includes an operation button 435a. The operation button 435a is used by the user to confirm that he or she wishes to change the reservation.

The reservation update confirmation screen 436 is used for inquiring to the user for a judgment of whether or not to make a reservation for a train selected by the user when the train for which the user has a reservation is delayed. The reservation update confirmation screen 436 includes a display 436a of the train number, departure time, arrival time and delay time of the train for which the user has a reservation, and operation buttons 436b and 436c. The operation button 436b is used for confirming that the user wishes to change the reservation, and the operation button 436b is used for confirming that the user wishes not to change the reservation.

(6) Input Unit 403

The input unit 403 includes various keys such as numeric keys, an OK key, and a select key. The input unit 403 receives instructions and information from the user by the keys being operated by the user.

When the setting screen 431 is displayed by the display unit 404, the input unit 403 receives an operation of either the operation button 431a or the operation button 4311b according to a user operation. On receiving an operation of the operation button 431a, the input unit 403 outputs a search mode setting instruction indicating setting of the search mode information to search mode, and on receiving an operation of the operation button 431b, the input unit 403 outputs a non-search mode setting instruction indicating setting the search mode information to non-search mode.

When the update confirmation screen 432 is displayed by the display unit 404, the input unit 403 receives an operation of either the operation button 432a or the operation button 432b according to a user operation. On receiving an operation of the operation button 432a, the input unit 403 outputs update information indicating updating of the reservation, to the control unit 402 as confirmation information. On receiving an operation of the operation button 432b, the input unit 403 outputs non-update information indicating non-updating of the reservation, to the control unit 402 as confirmation information.

When the train list screen 433 is displayed by the display unit 404, the input unit 403 receives a selection of one of the sets of train number and departure time according to a user operation. On receiving the selection, the input unit 403 outputs the train number and the departure time included in the selected set to the control unit 402.

When the reservation confirmation screen 434 is displayed by the display unit 404, the input unit 403 receives an operation of either the operation button 434b or the operation 434c according to a user operation. On receiving an operation of the operation button 434b, the input unit 403 outputs a reservation instruction indicating that a reservation is to be made, to the control unit 402. On receiving an operation of the operation button 434c, the input outputs a non-reservation instruction indicating that a reservation is not to be made, to the control unit 402.

When the reservation changing screen 435 is displayed by the display unit 404, the input unit 403 receives an operation of the operation button 435a according to a user operation. On receiving the operation of the operation button 435a, the input unit 403 outputs a reservation change instruction indicating changing of the reservation, to the control unit 402 as confirmation information.

When the reservation change confirmation screen 436 is displayed by the display unit 404, the input unit 403 receives input of either the operation button 436b or the operation button 436c. On receiving an operation of the operation button 436b, the input unit 403 outputs a reservation change instruction indicating changing the reservation, to the control unit 402 as confirmation information. On receiving an operation of the operation button 436c, the input unit 403 outputs a reservation non-change instruction indicating that the reservation is not to be changed, to the control unit 402 as confirmation information.

(7) Control Unit 402

The control unit 402 receives the following types of instructions from the input unit 403: a search mode setting instruction, a non-search mode setting instruction, an update instruction, a non-update instruction, a reservation instruction, a non-reservation instruction, a reservation change instruction, and a reservation non-change instruction, and also receives a train number and a departure time from the input unit 403. Furthermore, the control unit 402 receives a location obtain request indicating obtaining a present location (latitude and longitude) indicating the location of the mobile telephone 400. Furthermore, the control unit 402 receives, from the memory card 200 via the input/output unit 401, a message indicating that the departure time is nearing and confirming whether or not the user would like to update the reservation. Furthermore, the control unit receives a message indicating a cancellation and a message indicating a delay, from the reservation center apparatus 300 via the Internet 20, the mobile telephone network 10, and the radio base station 11.

On receiving a search mode setting instruction or a non-search mode setting instruction, the control unit 402 instructs the memory card 200, via the input/output unit 401, to set the search mode information to present location search mode or non-search mode, respectively.

On receiving an update instruction or a non-update instruction from the input unit 403, the control unit 402 outputs to the memory card 200, via the input/output unit 401, an update instruction or a non-update instruction, respectively.

On receiving a reservation change instruction or a reservation non-change instruction from the input unit 403, the control unit 403 outputs the received reservation change instruction or reservation non-change instruction to the reservation center apparatus 300 via the telephone communication control unit 405, the telephone communication unit 408, the antenna 413, the radio base station 11, the mobile telephone network 10, and the Internet 20.

On receiving a reservation instruction or a non-reservation instruction from the input unit 403, the control unit 403 outputs the received reservation instruction or non-reservation instruction to the reservation center apparatus 300 via the telephone communication control unit 405, the telephone communication unit 408, the antenna 413, the radio base station 11, the mobile telephone network 10, and the Internet 20.

On receiving a location obtain request, the control unit 402 outputs a location obtain instruction indicating obtaining the present location, to the GPS communication control unit 409, the GPS communication unit 410, and the antenna 414, receives the present location (latitude and longitude) from the GPS communication control unit 409, and outputs the received present location (latitude and longitude) to the memory card 200 via the input/output unit 401.

On receiving an update message indicating that departure time is nearing and that it should be checked whether or not the user wishes to update the reservation, the control unit 402 controls the display unit 404 so as to display the update confirmation screen 432.

Furthermore, on receiving a message indicating cancellation of a service or a message indicating a delay from the reservation center apparatus 300, the control unit 402 controls the display unit 404 so as to display either the reservation change screen 435 or the reservation change confirmation screen 436.

1.6 Timetable Server Apparatus 500

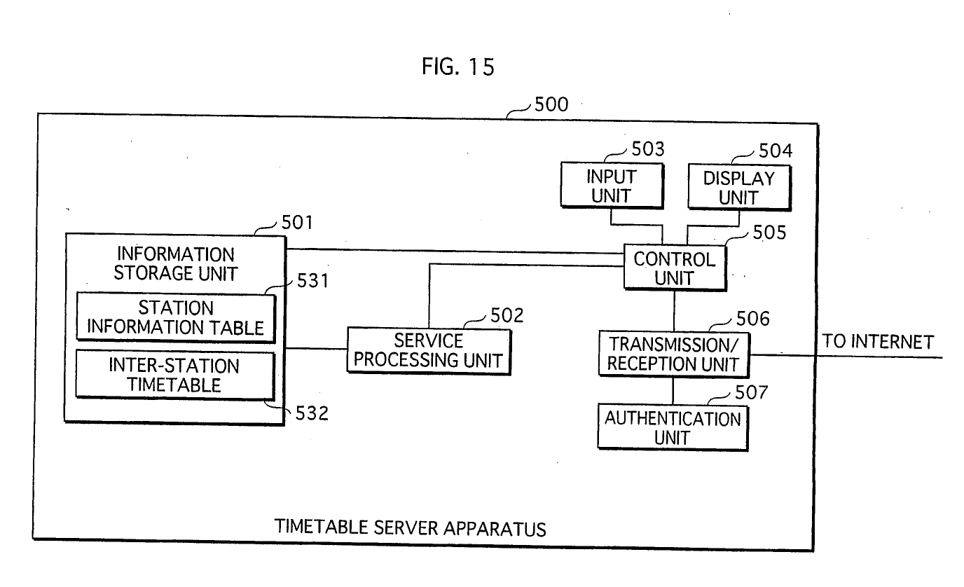

The timetable server apparatus 500, as shown in FIG. 15, is composed of an information storage unit 501, a service processing unit 502, an input unit 503, a display unit 504, a control unit 505, a transmission/reception unit 506, and an authentication unit 507.

The timetable server apparatus 500 is a computer system similar to the reservation center apparatus 300, and, specifically, is composed of a microprocessor, a ROM, a RAM, a hard disk unit, a display unit, a keyboard, a mouse, a LAN connection unit, and the like. Computer programs are stored in the RAM or the hard disk unit, and the timetable server apparatus 500 achieves its functions by the microprocessor operating according to the programs.

(1) Information Storage Unit 501

The information storage unit 501, as shown in FIG. 15, has a station information table 531 and an inter-station timetable 532.

<Station Information Table 531>

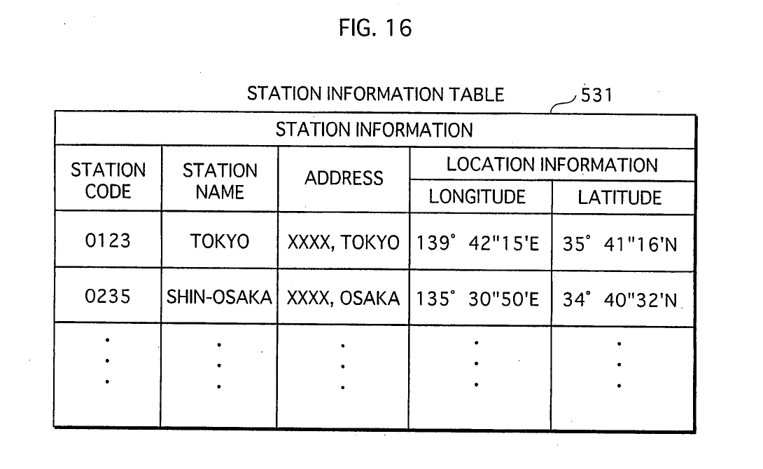

The station information table 531, as one example shown by the data structure shown in FIG. 16, includes a plurality of pieces of station information, each of which is composed of a station code, a station name, an address, and location information.

The station code is identification information that identifies the station. The station name is a name that identifies the station. The address is the street address of the station. The location information indicates the latitude and longitude of the location of the station.

<Inter-Station Timetable 532>

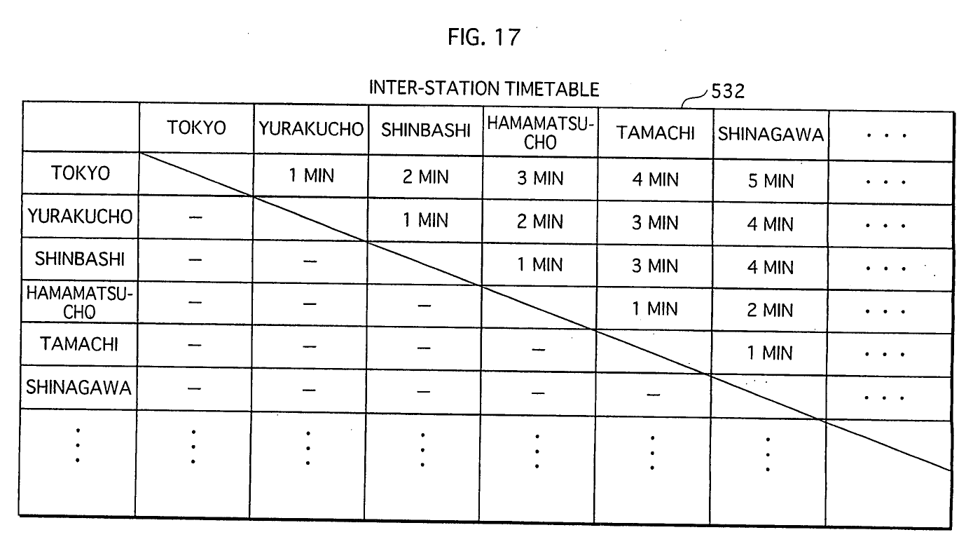

The inter-station timetable 532, as one example shown by the data structure shown in FIG. 17, is a data table indicating the approximate time required for travel between various stations.

(2) Control Unit 505

The control unit 505 receives a device authentication request from the memory card 200 via the mobile telephone 400, the radio base station 11, the mobile telephone network 10, Internet 20, and the transmission/reception unit 506. On receiving the request, the control unit 505 controls the authentication unit 507 so as to perform device authentication with the memory card 200.

When device authentication with the memory card 200 is successful, the control unit 505 receives a distance obtain request, a present location and a boarding station from the memory card 200 via the mobile telephone 400, the radio base station 11, the mobile telephone network 10, the Internet 20 and the transmission/reception unit 506, and outputs the received distance obtain request, present location and boarding station to the service processing unit 502. Next, the control unit 505 receives a calculated distance from the service processing unit 502, and transmits the received distance to the memory card 200 via the transmission/reception unit 506, the Internet 20, the mobile telephone network 10, the radio base station 11, and the mobile telephone 400.

Furthermore, the control unit 505 receives an expected arrival time obtain request, a present location and a boarding station. On receiving the expected arrival time obtain request, the present location and the boarding station, the control unit 505 reads station information that includes location information of a location closest to the received present location, and extracts the station name included in the read station information. Next, the control unit 505 extracts the approximate time between the station identified by the extracted station name and the received boarding station from the inter-station timetable, adds the present time to the extracted approximate time, thereby calculating the expected arrival time, and transmits the calculated expected arrival time to the memory card 200 via the transmission/reception unit 506, the Internet 20, the mobile telephone network 10, the radio base station 11, and the mobile telephone 400.

(3) Service Processing Unit 502

The service processing unit 502 receives a distance obtain request, a present location and a boarding station from the control unit 505. On receiving the distance obtain request, the present location and the boarding station, the service processing unit 502 reads a piece of station information that includes a station name corresponding to the received boarding station, from the station information table 531, and extracts the location information (latitude and longitude) from the read station information. Next, the service processing unit 502 calculates the distance between the location indicated by the present location and the location indicted by the extracted location information, with use of the received present location (latitude and longitude) and the extracted location information (latitude and longitude), and outputs the calculated distance to the control unit 505.

(4) Transmission/Reception Unit 506

The transmission/reception unit 506 connects to an external apparatus via the Internet 20. The transmission/reception unit 506 transmits and receives information to and from the external apparatus.

(5) Authentication Unit 507

The authentication unit 507 performs mutual device authentication under the control of the control unit 505 with the memory card 200 via the transmission/reception unit 506, the Internet 20, the mobile telephone network 10, the radio base station 11, and the mobile telephone 400.

(6) Input Unit 503 and Display Unit 504

The input unit 503 receives instructions and information from the user of the timetable server apparatus 500, and outputs the received instructions and information to the control unit 505.

The display unit 504 displays various information under the control of the control unit 505.

1.7 Ticket Vending Machine 600

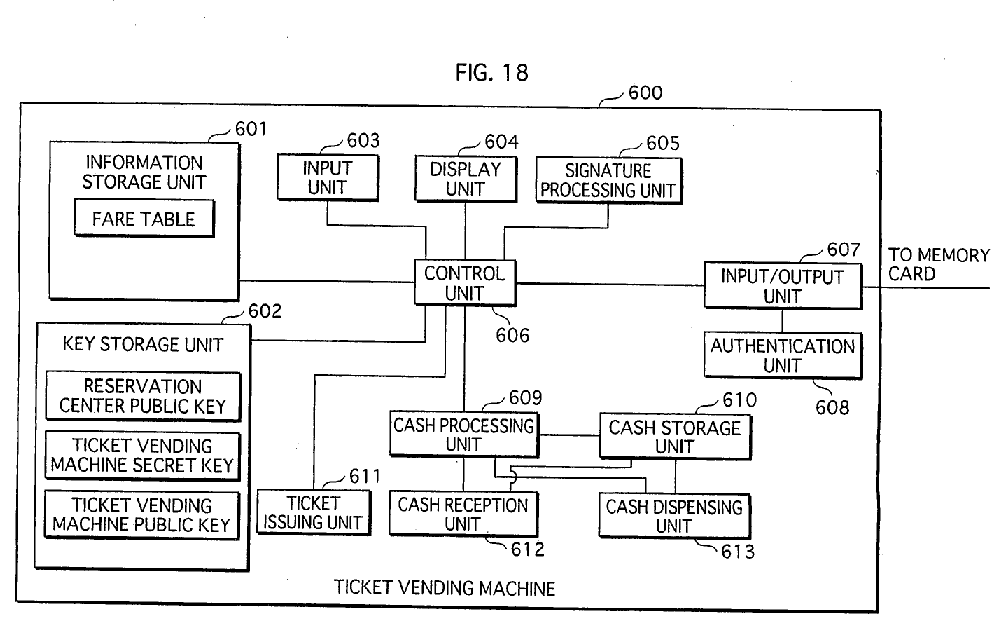

The ticket vending machine 600, as shown in FIG. 18, is composed of an information storage unit 601, a key storage unit 602, an input unit 603, a display unit 604, a signature processing unit 605, a control unit 606, an input/output unit 607, an authentication unit 608, a cash processing unit 609, a cash storage unit 610, a ticket issuing unit 611, a cash receiving unit 612, and a cash dispensing unit 613.

The ticket vending machine 600 is a computer system similar to the reservation center apparatus 300, and, specifically, is composed of a microprocessor, a ROM, a RAM, and so on. Computer programs are stored in the RAM, and the ticket vending machine 600 achieves part of its functions by the microprocessor operating according to the computer programs.

(1) Information Storage Unit 601 and Key Storage Unit 602

The information storage unit 601, as shown in FIG. 18, stores a fare table. The fare table is a data table showing fares between stations.

The key storage unit 602, as shown in FIG. 18, stores a reservation center public key, a ticket vending machine secret key, and a ticket vending machine public key.

The reservation center public key is as described earlier, and therefore a description thereof is omitted here.

The ticket vending machine secret key is a secret key generated according to a public key generation method that uses encryption on an elliptic curve. The security of the encryption on the elliptic curve is based on a discrete logarithm problem on the elliptic curve. Furthermore, the ticket vending machine public key is generated based on the ticket vending machine secret key, according to the public key generation method.

(2) Input Unit 603

The input unit 603 includes a plurality of destination station buttons, a plurality of fare buttons, a reserved ticket issue button, and a cancel button.

When one of the destination station buttons is operated by a user, a ticket to the station indicated by the destination station button is issued. Furthermore, when one of the fare buttons is operated by a user, a ticket is issued for a section that may be traveled in for the fare indicated by fare button. When the reserved ticket issue button is operated by a user, a ticket issue information table is generated based on reservation information included in the reservation information table 232 stored in the memory card 200, and the generated ticket issue information table is written to the memory card 200. Furthermore, when the cancel button is operated by a user, operations performed by the user up to the point of pressing the cancel button are cancelled.

When any one of the plurality of destination station buttons, the plurality of fare buttons, the reserved ticket issue button or the cancel button is operated by the user, the input unit 603 outputs instruction information corresponding to the operated button to the control unit 606.

(3) Input/Output Unit 607

The input/output unit 607 is connected to the memory card 200 by the memory card 200 being inserted into the ticket vending machine 600 by the user. When the memory card 200 and the input/output unit 607 are connected, the input/output unit 607 receives and transmits information between the memory card 200 and the authentication unit 608. In addition, the input/output unit 607 receives and transmits information between the memory card 200 and the control unit 606.

(4) Authentication Unit 608

On the memory card 200 being connected to the input/output unit 607, the authentication unit 608 performs mutual device authentication with the memory card 200.

(5) Display Unit 604

The display unit 604 displays various information under the control of the control unit 606.

(6) Control Unit 606

The control unit 606 receives instruction information respectively corresponding to the plurality of destination station buttons, the plurality of fare buttons, the reserved ticket issue button, and the cancel button from the input unit 603.

On receiving instruction information corresponding to any one of the plurality of destination station buttons, the plurality of fare buttons, and the cancel button, the control unit 606 performs processing corresponding to the instruction information.

On receiving the reservation ticket issue button, the control unit 606 outputs a reservation information request indicating a request for reservation information, to the memory card 200 via the input/output unit 607.

Furthermore, the control unit 606 receives one set of reservation information and reservation signature data, from the memory card 200 via the input/output unit 607, outputs the received reservation information to the display unit 604, and controls the display unit 604 so as to display the reservation information.

Furthermore, the control unit 606 receives reservation information selected by the user from among the displayed one or more pieces of reservation information. The control unit 606 then controls the signature processing unit 605 so as to perform digital signature processing of the reservation signature data corresponding to the received reservation information.

If digital signature processing fails, the control unit 606 stops processing with respect to the piece of reservation information.

If digital signature processing succeeds, the control unit 606 calculates the fare with use of the selected reservation information, and calculates the express surcharge if the train to be used is an express train. The control unit 606 then controls the cash processing unit 609 so as to receive cash equivalent to the fare or to the fare and the express surcharge.

Next, the control unit 606 generates ticket issue information in the following manner, with use of the reservation information. Here, the ticket issue information includes a ticket issue number, a travel date, a train number, a boarding station, a destination station, a departure time, an arrival time, a fare, an express surcharge, a seat number, a payment method, a processing segment, an entry time, and an exit time. A description of these is omitted.

The control unit 606 generates a ticket issue number that identifies the ticket issue information, using the travel date, the train number, the boarding station, the destination station, the departure time, the arrival time, and seat number included in the reservation information as the travel date, the train number, the boarding station, the destination station, the departure time, the arrival time, and seat number, using the calculated fare and express surcharge as the fare and express surcharge in the ticket issue information, making the payment method “cash”, making the processing segment “unprocessed”, and leaving the entry time and the exit time blank.

Next, the control unit 606 controls the signature processing unit 605 so as to generate ticket issue signature data based on the ticket issue information, and receives the ticket issue signature information from the signature processing unit 605.

The control unit 606 then outputs the generated ticket issue information and the receives ticket issue signature data to the memory card 200 via the input/output unit 607.

(7) Signature Processing Unit 605

Under the control of the control unit 606, the signature processing unit 605 receives reservation information from the control unit 606, reads the ticket vending machine secret key from the key signature unit 602, applies a digital signature SIG to the received reservation information with use of the read ticket vending machine secret key, thereby generating ticket issue signature data, and outputs the generated signature data to the control unit 606.

(8) Cash Receiving Unit 612, Cash Processing Unit 609, Cash Storage Unit 610, and Cash Dispensing Unit 613

The cash storage unit 610 stores cash.

The cash receiving unit 612 receives cash payment from the user, and stores the received cash in the cash storage unit 610.

The cash processing unit 609 counts the cash paid by the user, and calculates the difference between the fare and the received cash. If the amount of the cash is insufficient, the cash processing unit 609 controls the cash receiving unit 612 so as to wait for further cash payment, and if the amount of the cash is excessive; controls the cash dispensing unit 613 so as to obtain cash equal to the extra amount, in other words, change, from the cash storage unit 610 and return the change to the user.

The cash dispensing unit 613 obtains the amount equal to the difference, in other words, obtains change, from the cash storage unit 610, and returns the change to the user.

(9) Ticket Issuing Unit 611

The ticket issuing unit 611 prints, and then issues, a ticket.

1.8 Automated Ticket Inspection Machine 700

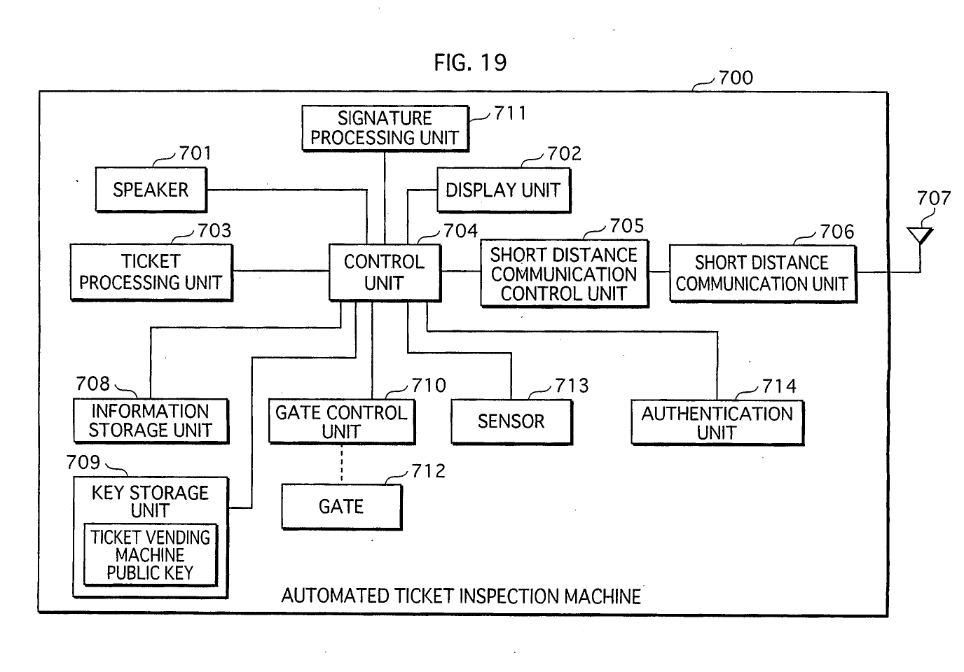

The compositional elements of the automated ticket inspection machine 700, as shown in FIG. 19, include a speaker 701, a display unit 702, a ticket-processing unit 703, a control unit 704, a short distance communication control unit 705, a short distance communication unit 706, an antenna 707, an information storage unit 708, a key storage unit 709, a gate control unit 710, a signature processing unit 711, a gate 712, a sensor 713, and an authentication unit 714.

The automated ticket inspection machine 700 is a computer system similar to the ticket vending machine 600, and, specifically, is composed of a microprocessor, a ROM, a RAM, and so on. Computer programs are stored in the RAM, and the automated ticket inspection machine 700 achieves part of its functions by the microprocessor operating according to the computer programs.

Note that the automatic automated ticket inspection machines 751 and 752 have the same structure as the automated ticket inspection machine 700, and therefore a description thereof is omitted here.

(1) Information Storage Unit 708 and Key Storage Unit 709

The information storage unit 708 has an area for storing various types of information.

The key storage unit 709 stores the ticket vending machine public key. The ticket vending machine public key is as described earlier, and therefore a description thereof is omitted here.

(2) Ticket Processing Unit 703

The ticket processing unit 703 inspects various items of received ticket information. Specifically, the ticket processing unit 703 inspects in the following manner.

The ticket processing unit 703 inspects whether or not: (i) the travel date is the present date; (ii) the boarding station is the station at which the automated ticket inspection machine 700 is located; (iii) the departure time is later than the present time; and (iv) the processing segment indicates “unprocessed”.

When all these conditions are fulfilled, the ticket processing unit 703 judges that the ticket information has passed the inspection, and when all these conditions are not fulfilled, the ticket processing unit 703 judges that the ticket information has failed the inspection.

Next, the ticket processing unit 703 outputs an inspection result indicating whether or not the ticket information has passed or failed the inspection to the control unit 704.

(3) Control Unit 704

The control unit 704 receives establishment information indicating whether or not establishment of a communication channel has succeeded or failed, from the short distance communication control unit 705.

When the received establishment information indicates that establishment of the communication channel has failed, the control unit 704 ends communication with the mobile telephone 400. On the other hand, when the received establishment information indicates that establishment of the communication channel has succeeded, the control unit 704 commences communication with the mobile telephone 400. Subsequent communication with the mobile telephone 400 is performed via the established communication channel.

When the communication channel has been established in this way, the control unit 704 controls the authentication unit 714 so as to perform mutual device authentication with the memory card 200.

When authentication with the memory card 200 succeeds, the control unit 704 requests ticket issue information from the memory card 200 via the mobile telephone 400.

Next, the control unit 704 receives ticket issue information and ticket issue signature data from the memory card 200 via the mobile telephone 400, outputs the received ticket issue signature data, and controls the signature processing unit 711 so as to perform digital signature verification.

The control unit 704 receives a verification result of the digital signature verification from the signature processing unit 711, and when the result indicates that verification failed, the control unit 704 controls the gate control unit 710 so as to close the gate 712. When the verification result shows that verification succeeded, the control unit 704 controls the gate control unit 710 so as to open the gate 712.

Furthermore, the control unit 704 outputs the ticket issue information to the ticket processing unit 703, and controls the ticket processing unit 703 so as to inspect the ticket issue information. Next, the control unit 704 receives the result of the inspection from the ticket processing unit 703, and when the received result indicates that the ticket issue information has not passed the inspection, controls the gate control unit 710 so as to close the gate 712. When the received result indicates that the ticket issue information has passed the inspection, the control unit 704 controls the gate control unit 710 so as to open the gate 712.

Furthermore, the control unit 704 generates a processing segment indicating “entered”, generates an entry time indicating the present time, and outputs the generated processing segment and entry time to the memory card 200 via the mobile telephone 400.

(4) Short Distance Communication Control Unit 705, Short Distance Communication Unit 706, and Antenna 707

The short distance communication control unit 705, the short distance communication unit 706, and the antenna 707 perform radio transmission and reception of information to and from the mobile telephone 400 using a frequency band of 2.4 GHz.

The short distance communication unit 706 includes a transmission/reception unit that receives and transmits signals via the antenna 707, and a modulation/demodulation unit that modulates and demodulates signals. The short distance communication control unit 705 processes various types of signals input by and output to the short distance communication unit 706. In addition, the short distance communication control unit 705 establishes a communication channel for short distance radio communication between the short distance communication control unit 411 of the mobile telephone 400, and subsequently communicates via the established communication channel.

(5) Authentication Unit 714

The authentication unit 714 performs mutual device authentication with the memory card 200 under the control of the control unit 704.

(6) Signature Processing Unit 711

Under the control of the control unit 704, the signature processing unit 711 receives ticket issue signature data, reads the ticket vending machine public key from the key storage unit 709, performs digital signature verification of the received ticket issue signature data using the read ticket vending machine public key, and outputs a verification result of the digital signature verification to the control unit 704.

(7) Speaker 701, Display Unit 702 and Sensor 713

The speaker 701 outputs various audio messages under the control of the control unit 704. The display unit 702 displays various types of information under the control of the control unit 704. The sensor 713 senses when a user passes.

(8) Gate Control Unit 710 and Gate 712

The gate control unit 710 controls opening and closing of the gate 712 under the control unit 704. The gate 712 opens and closes under the control of the gate control unit 710, thereby permitting or preventing a user to pass through.

1.9 Operations of the Transport Ticket System

The following describes operations of the transport ticket system 1.

(1) Reservation Operations

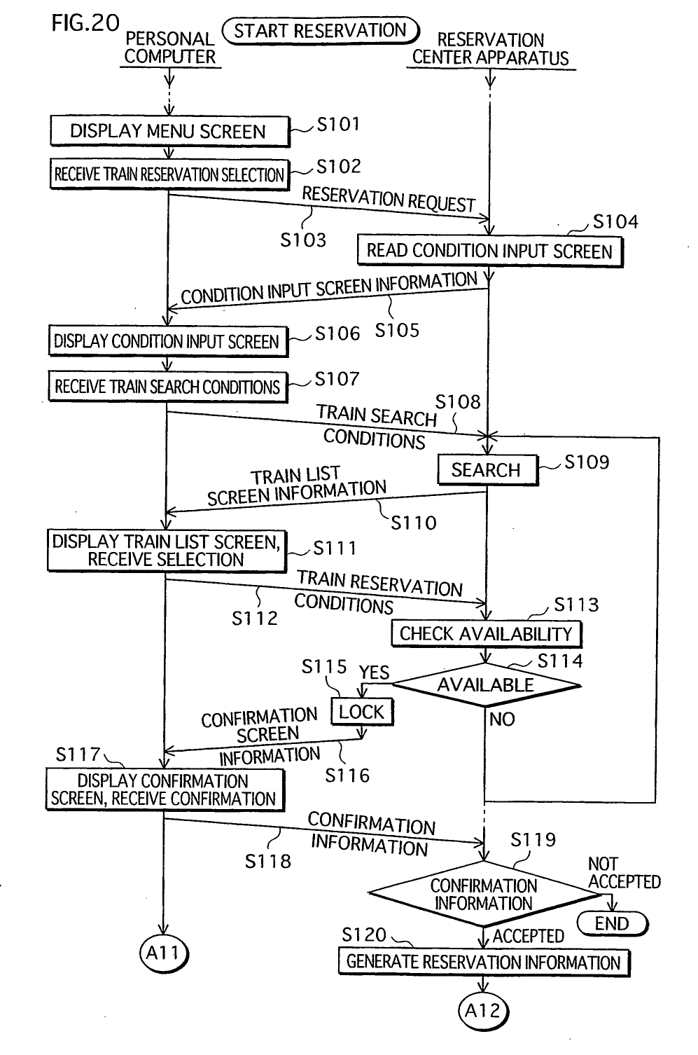

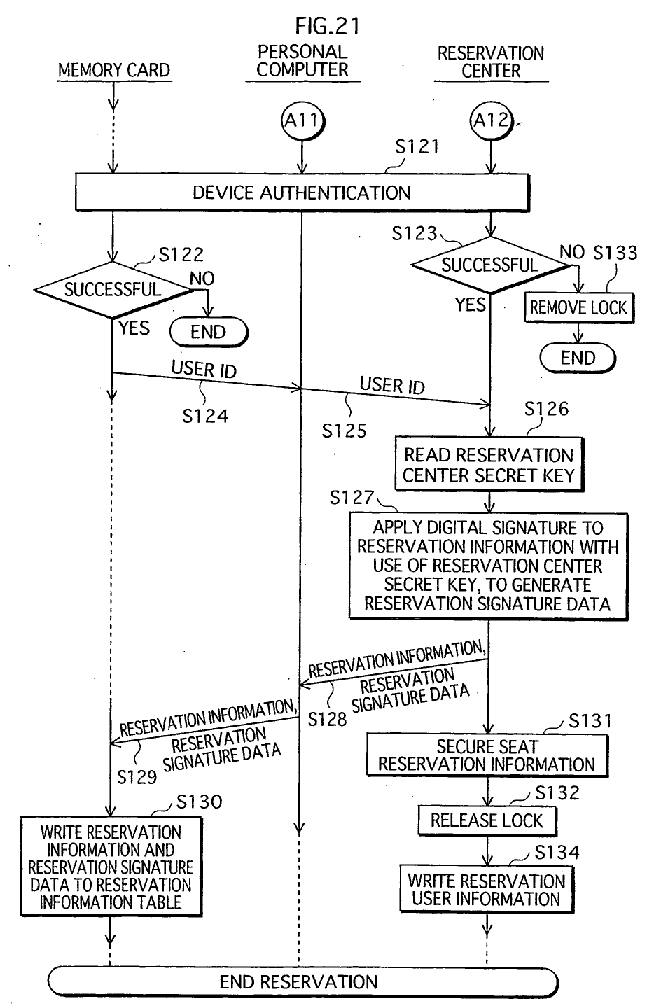

The following describes reservation operations for making a reservation in the travel ticket system 1, with use of the flowcharts in FIG. 20 and FIG. 21.

The display unit 105 of the personal computer 100 displays the menu screen 121 (step S101). The input unit 104 receives a selection of a train reservation according to a user operation, generates a reservation request indicating starting of train reservation processing, and outputs the generates reservation request to the control unit 101 (step S102). The control unit 101 transmits the received reservation request to the reservation center apparatus 300 via the communication unit 106 and the Internet 20 (step S103).

The control unit 310 of the reservation center apparatus 300 receives the reservation request from the personal computer 100 via the Internet 20 and transmission/reception unit 308 (step S103).

The screen generation unit 306 reads the condition screen information from the screen information storage unit 303 (step S104), and transmits the read condition input screen information to the personal computer 100 via the transmission/reception unit 308 and the Internet 20 (step S105).

Next, the control unit 101 of the personal computer 100 receives the condition input screen information from the reservation center apparatus 300 via the Internet 20 and the communication unit 106 (step S105) and generates the condition input screen 122 using the received condition input screen information, and the display unit 105 displays the condition input screen 122 (step S106). The input unit 104 receives input of a travel date, a travel time, a train name, a boarding station and a destination station according to a user operation. The control unit 101 receives train search conditions made up of the travel date, the travel time, the departure time, the train name, the boarding station and the destination station (step S107), and transmits the received train search conditions to the reservation center apparatus 300 via the communication unit 106 and the Internet 20 (step S108).

The control unit 310 of the reservation center apparatus 300 receives the train search conditions made up of the travel date, the travel time, the train time, the train name, the boarding station and the destination station from the personal computer 100 via the Internet 20 and the transmission reception unit 308 (step S108), and, using the train reservation table 331 and the train service schedule information table 333, the search unit 305 generates train list screen information that includes information of one or more trains that fulfill the received train search conditions (step S109) and transmits the generated train list screen information to the personal computer 100 via the transmission/reception unit 308 and the Internet 20 (step S110).

Next, the control unit 101 of the personal computer 100 receives the train list screen information from the reservation center apparatus 300 via the Internet 20 and the communication unit 106 (step S110). The display unit 105 displays the train list screen 123, the input unit 104 receives a selection of one selection button according to a user operation, and the control unit 101 extracts the train number corresponding to the selection button for which the selection was received and generates train reservation conditions (step S111). The control unit 101 then outputs the generated train reservation conditions to the reservation center apparatus 300 via the communication unit 106 and the Internet 20 (step S112).

The control unit 310 of the reservation center 300 receives the train reservation conditions from the personal computer 100 via the Internet 20 and the transmission/reception unit 308 (step S112). The reservation processing unit 304 checks whether or not seat reservation information that fulfills the received train reservation conditions exists in the train reservation table 331 (step S113). When such seat reservation information does not exist (step S114), the processing is repeated from step S109.

When segment information that fulfills the received train reservation conditions exists in the train reservation table 331 (step S114), the reservation processing unit 304 selects one piece of the segment information that fulfills the received train reservation conditions, and locks the selected piece of segment information in the train reservation table 331 (step S115). Next, the screen generation unit 306 receives train service schedule information and train reservation information from the reservation processing unit 304, reads confirmation screen information from the screen information storage unit 303, generates, with use of the read confirmation screen information and the received train service schedule information and train reservation information, confirmation screen information for displaying the confirmation screen 124, and transmits the generated confirmation screen information to the personal computer 100 via the transmission/reception unit 308 and the Internet 20 (step S116).

The control unit 101 of the personal computer 100 receives the confirmation screen information from the reservation center apparatus 300 via the Internet 20 and the communication unit 106 (step 116), generates the confirmation screen 124 using the received confirmation screen information, and the display unit 105 displays the confirmation screen 124. The input unit 104 receives a selection of either the operation button 124b or the operation 124c, and outputs confirmation information indicating acceptance or non-acceptance, corresponding to the one of the operation buttons 124b and 124c for which the selection was received (step S117). The control unit 101 transmits the received confirmation information to the reservation center apparatus 300 via the Internet 20 (step S118).

The control unit 310 of the reservation center apparatus 300 receives the confirmation information that indicates either acceptance or non-acceptance of the user with respect to the described confirmation, from the personal computer 100 via the Internet 20 and the transmission/reception unit 308 (step S118), and when the received confirmation information indicates non-acceptance (step S119), the processing stops. When the received confirmation information indicates acceptance (step S119), the reservation processing unit 304 generates reservation information (step S120).

Next, the authentication unit 307 of the reservation center apparatus 300 and the authentication unit 204 of the memory card 200 perform mutual device authentication (step S121).

When device authentication succeeds (step S122), the control unit 202 of the memory card 200 reads the user ID from the secure area 211, and transmits the read user ID to the reservation center apparatus 300 via the personal computer 100 and Internet 20 (steps S124 and S125). When device authentication fails (step S122), the memory card 200 stops the processing.

When the device authentication fails (step S123), the reservation processing unit 304 of the reservation center apparatus 300 releases the lock from the section information (step S133), and stops the processing. When device authentication succeeds (step S123), the control unit 310 receives the user ID from the memory card 200 via the personal computer 100 and the Internet 20 (steps S124, S125). Next, the signature unit 309 reads the reservation center secret key from the key storage unit 302 (step S126), receives the reservation information from the reservation processing unit 304, applies a digital signature SIG to the received reservation information with use of the read reservation center secret key, thereby generating reservation signature data, and outputs the generated reservation signature data to the reservation processing unit 304 (step S127). The reservation processing unit 304 receives the reservation signature from the signature unit 309, and transmits the received reservation signature data and the generated reservation information to the memory card 200 via the transmission/reception unit 308, the Internet 20, and the personal computer 100 (steps S128 and S129).

The input/output unit 203 of the memory card 200 receives the reservation signature data and the reservation information, and writes the received reservation signature data and reservation information to the general area 212 (step S130).

Meanwhile, the reservation processing unit 304 of the reservation center apparatus 300 writes the reservation number to the locked segment information (step S131), releases the lock (step S132), adds the user ID to the reservation information, thereby generating the reservation user information, and writes the generated reservation user information to the reservation user table 332 (step S134).

(2) Device Authentication Operations by Authentication Unit 204 and Authentication Unit 307

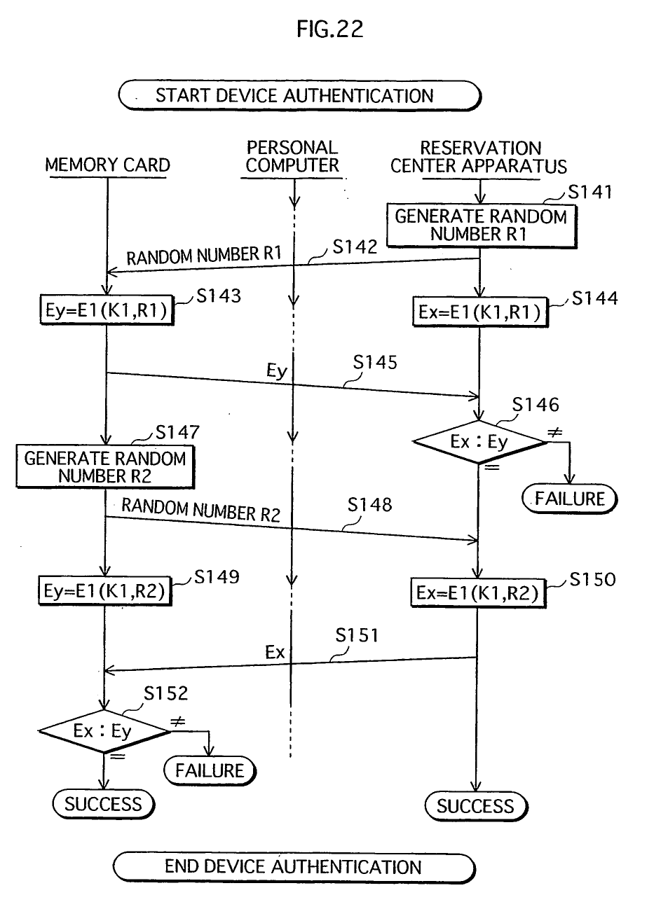

The following describes operations for device authentication by the authentication unit 204 of the memory card 200 and the authentication unit 307 of the reservation center apparatus 300, with use of the flowchart shown in FIG. 22.

The authentication unit 307 generates a random number R1 (step S141), generates a ciphertext Ex=E1(K1,R1) (step S144), and outputs the generated random number R1 to the authentication unit 204 via the personal computer 100 (step S142).

The authentication unit 204 receives the random number R1 (step S142), generates a ciphertext Ey=E1 (K1,R1) (step S143), and outputs the generated ciphertext Ey to the authentication unit 307 via the personal computer 100 (step S145). Next, the authentication unit 307 judges whether the generated ciphertext Ex and the received ciphertext Ey match, and if the two do not match (step S146), considers authentication to have failed.

Next, the authentication unit 204 generates a random number R2 (step S147), generates a cipher text Ey=E1(K1,R2) (step S149), and outputs the generated random number R2 to the authentication unit 307 via the personal computer 100 (step S148).

When the two ciphertexts match (step S146), the authentication unit 307 receives the random number R2 (step S148), generates a ciphertext Ex=E1(K1,R2) (step S150), and outputs the generated ciphertext Ex to the authentication unit 204 via the personal computer 100 (step S151). Next, the authentication unit 204 judges whether or not the generated ciphertext Ey and the received ciphertext Ex match, and when the two do not match (step S152), considers device authentication to have failed, and when the two match (step S152), considers device authentication to have succeeded.

Here, E1 expresses an encryption algorithm, and A=E1(K,R) expresses a ciphertext A generated by applying the encryption algorithm E1 to a plaintext R with use of a key K. Note that, as one example, E1 may be an encryption algorithm according to DES (data encryption standard).

(2) Operations for Changing a Reservation

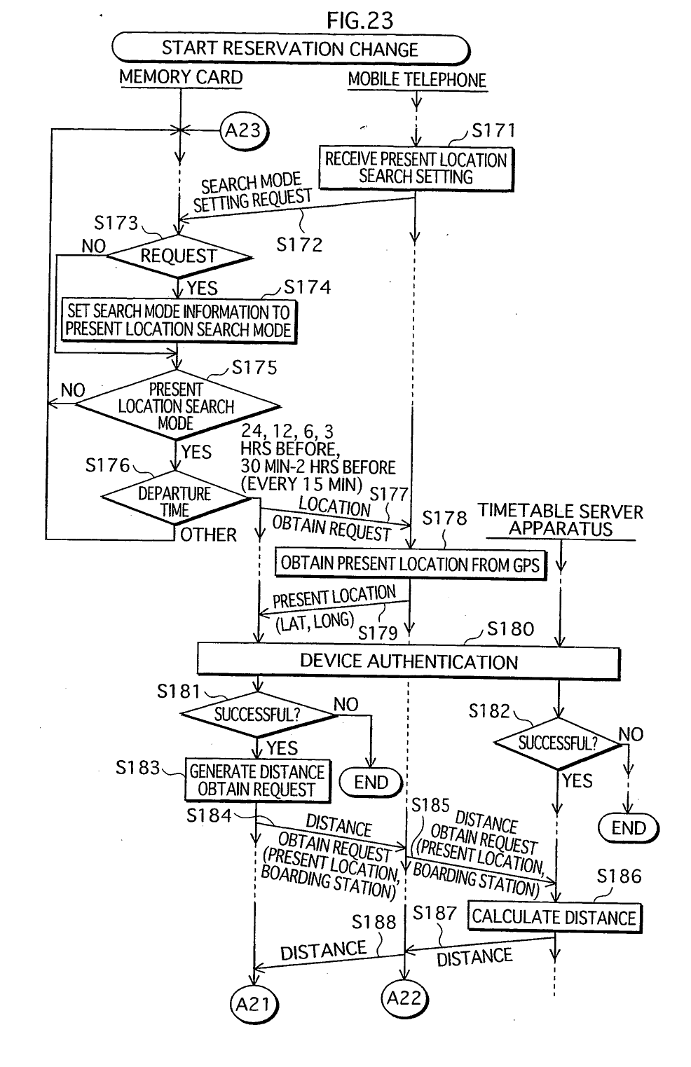

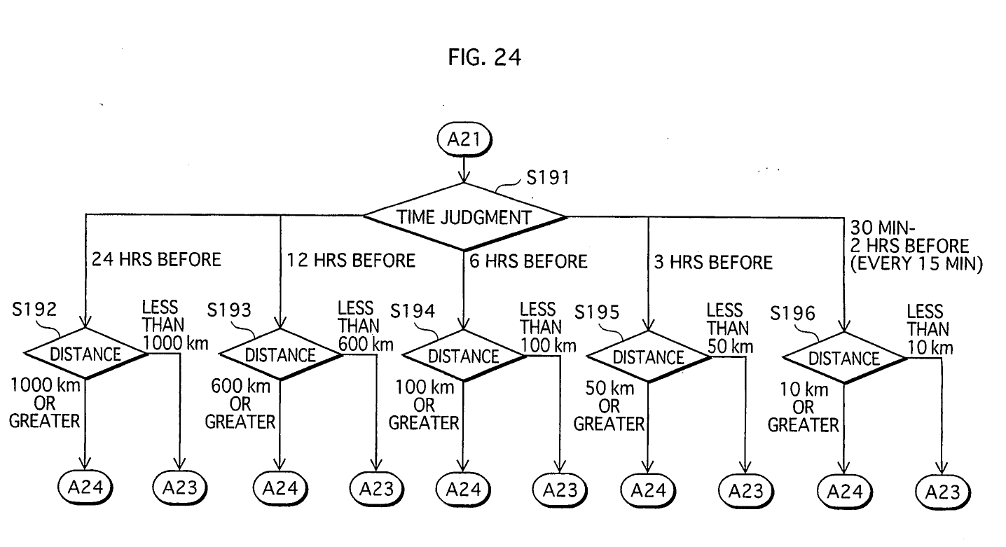

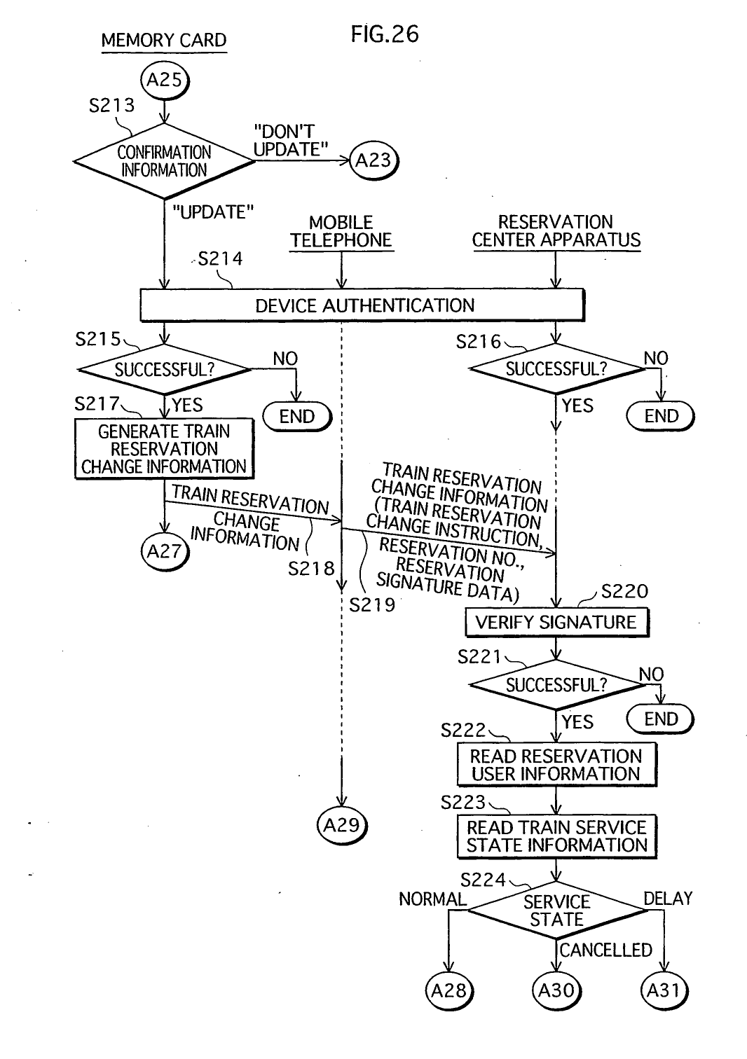

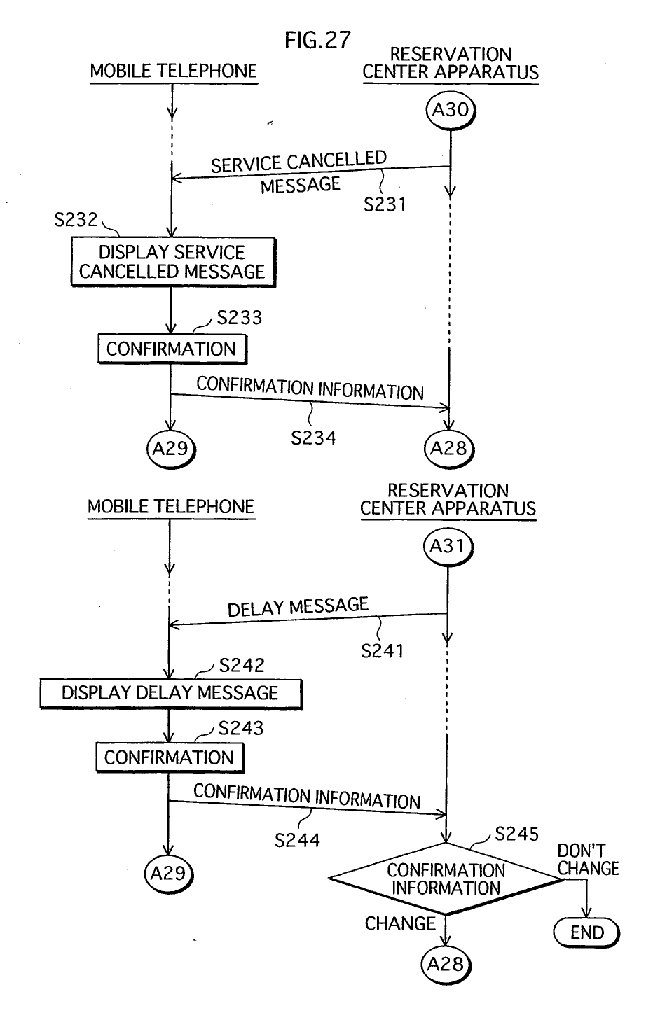

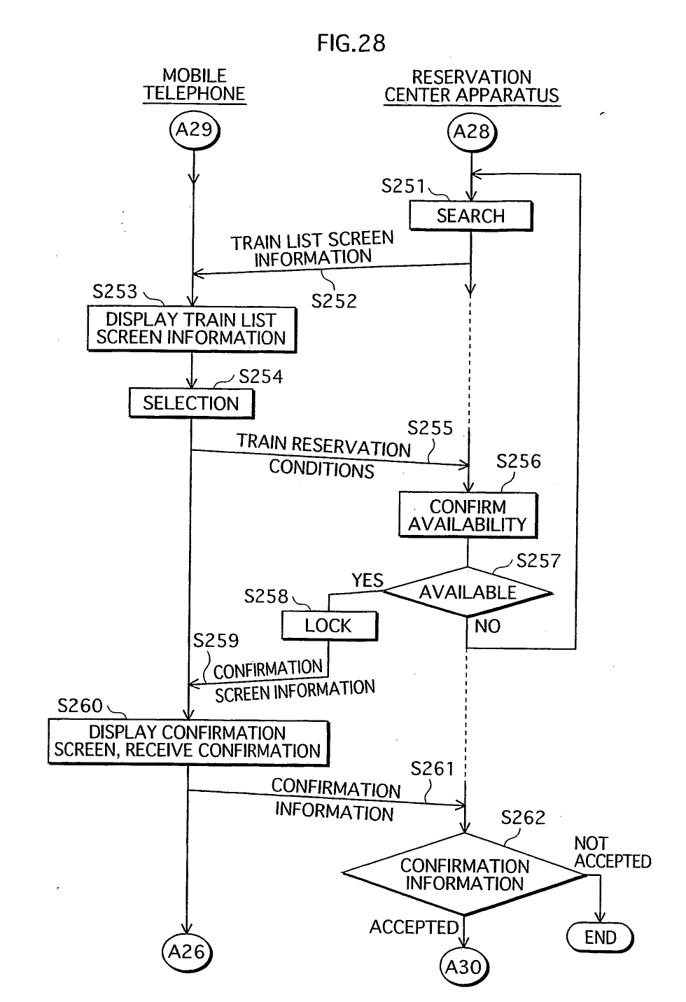

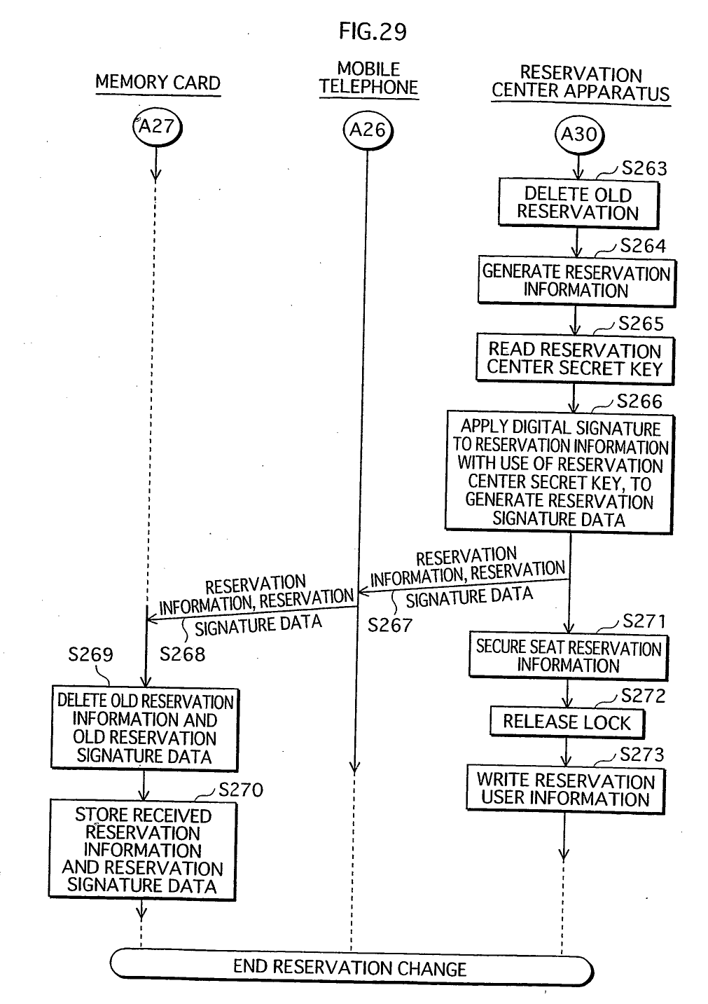

The following describes operations for changing a reservation in the transport ticket system 1, with use of the flowcharts in FIG. 23 to FIG. 29.

The display unit 404 of the mobile telephone 400 displays the setting screen 431, and the input unit 403 receives an operation of the operation button 431a according to a user operation and outputs a search mode setting instruction to the control unit 402 (step S171). The control unit 402 instructs the memory card 200 via the input/output unit 401 to set the search mode information to present location search mode (step S172).

The input/output unit 203 of the memory card 200, on receiving an instruction indicating setting the search mode information 233 to present location search mode (step S173), sets the search mode information 233 in the general area 212 to present location search mode (step S174).

Next, the control unit 202 judges whether the search mode information 233 indicates present search mode, and when the search mode information 233 does not indicate present search mode (step S175), the control unit 202 returns to step S173 without performing reservation change processing, and waits again for an instruction for setting the search mode information 233.

On judging that the search mode information 233 indicates present search mode (step S175), the control unit 202 compares, for each piece of reservation information in the reservation information table 232 stored in the general area 212, the departure time in the piece of reservation information with the present time, and judges whether the present time is 24 hours, 12 hours, 6 hours, 3 hours, 2 hours, 1 hour 45 minutes, 1 hour 30 minutes, 1 hour 15 minutes, 1 hour, 45 minutes, or 30 minutes before the departure time (step S176). When the present time is none of these (step S176), the control unit 202 returns to step S173 without doing anything and waits again for an instruction to set the search mode information 233. When the present time is one of these times before the departure time (step S176), the control unit 202 outputs a location obtain request, which indicates obtaining of the present location (latitude and longitude) of the mobile telephone 400, to the mobile telephone 400 via the input/output unit 203 (step S177).

The control unit 402 of the mobile telephone 400 receives the location obtain request (step S177). The GPS communication control unit 409 outputs a request to obtain the present location to the GPS 410 and the antenna 414, and calculates the present location (latitude and longitude) (step S178). The control unit 402 receives the present location (longitude and latitude) from the GPS communication control unit 409, and outputs the received present location (latitude and longitude) to the memory card 200 via the input/output unit 401 (step S179).

The authentication unit 204 of the memory card 200 and the authentication unit 507 of the timetable server apparatus 500 perform mutual device authentication (step S180).

When device authentication with the timetable server succeeds (step S181), the control unit 202 of the memory card 200 generates a distance request indicating obtaining of the distance between the present location (latitude and longitude) and the boarding station, extracts the boarding station from the reservation information (step S183), and transmits the generated distance obtain request, the received present location and the extracted boarding station to the timetable server apparatus 500 via the input/output unit 203, the mobile telephone 400, the radio base station 11, the mobile telephone network 10, and the Internet 20 (steps S184 and S185).

When authentication with the memory card 200 succeeds (step S182), the control unit 505 of the timetable server apparatus 500 receives the distance obtain request, the present location and the boarding station from the memory card 200 via the mobile telephone 400, the radio base station 11, the mobile telephone network 10, the Internet 20, and the transmission/reception unit 506 (steps S184 and S185). The control unit 505 outputs the received distance obtain request, present location, and boarding station to the service processing unit 502, and the service processing unit 502 calculates the distance between the present location and the boarding station (step S186). The control unit 505 transmits the calculated distance to the memory card 200 via the transmission/reception unit 506, the Internet 20, the mobile telephone 10, the radio base station 11, and the mobile telephone 400 (steps S187 and S188).

Next, the control unit 202 of the memory card 200 receives the distance between the present location and the boarding station from the timetable server apparatus 500 via the Internet 20, the mobile telephone network 10, the radio base station 11, and the mobile telephone 400 (steps S187 and S188).

If the present time was judged to be 24 hours before the departure time in the comparison of the departure time and the present time described earlier (step S191), the control unit 202 judges whether or not the received distance is 1000 km or greater (step S192). When the received distance is judged to be less than 1000 km (step S192), the control unit 202 ends the reservation change search, and then moves control to step S173, and repeats the processing. When the received distance is judged to be 1000 km or greater (step S192), the control unit 202 continues the reservation change search, moving the control to step S201.

Similarly, when the present time is judged to be 12 hours, 6 hours or 3 hours before the departure time in the described comparison (step S191), the control unit 202 judges, respectively, whether or not the received distance is 600 km or greater (step S193), 100 km or greater (step S194), or 50 km or greater (step S195), and, depending on the result of the judgment, determines to either end or continue the reservation change search. When ending the reservation change search, the control unit 202 moves control to step S173, and when continuing the reservation change search, the control unit 202 moves control to step S201.

Similarly, when the present time is judged to be 2 hours, 1 hour 45 minutes, 1 hour 30 minutes, 1 hour 15 minutes, 1 hour, 45 minutes, or 30 minutes before the departure time in the described comparison (step S191), the control unit 202 judges whether or not the received distance is 10 km or greater (step S196), and, depending on the result of the judgment, determines to either end or continue the reservation change search. When ending the reservation change search, the control unit 202 moves control to step S173, and when continuing the reservation change search, the control unit 202 moves control to step S201.

When the control unit 202 has determined to continue the reservation change search, the control unit 202 generates an expected arrival time obtain request indicating obtaining an expected arrival time at the boarding station (step S201), and transmits the generated expected arrival time obtain request, the present location and the boarding station to the timetable server apparatus 500 via the input/output unit 203, the mobile telephone 400, the radio base station 11, the mobile telephone 10 and the Internet 20 (steps S202 and S203).

The control unit 505 of the timetable server apparatus 500 receives the expected arrival time obtain request, the present location and the boarding station from the memory card 200 via the mobile telephone 400, the radio base station 11, the mobile telephone network 10, the Internet 20 and the transmission/reception unit 506 (steps S202 and S203). Next, the control unit 505 reads station information that includes location information closest to the present location, and extracts the station name from the read station information. The control unit 505 then extracts the approximate time between the station identified by the extracted station name and the received boarding station, from the inter-station timetable, adds the extracted approximate time to the present time, thereby calculating the expected arrival time (step S204), and transmits the calculated expected arrival time to the memory card 200 via the transmission/reception unit 506, the Internet 20, the mobile telephone network 10, the radio base station 11, and the mobile telephone 400 (steps S205 and S206).

The control unit 202 of the memory card 200 receives the expected arrival time from the timetable server apparatus 500 via the Internet 20, the mobile telephone network 10, the radio base station 11 and the mobile telephone 400 (steps S205 and S206), and compares the departure time with an expected time obtained by adding five minutes to the expected arrival time (step S207). When the departure time is greater than or equal to the scheduled time (step S207), the control unit 202 ends the reservation change search and moves control to step S173. When the departure time is not greater than or equal to the expected time (step S207), since the departure time is nearing, the control unit 202 generates an update message for confirming with the user whether or not to update the reservation (step S208), and outputs the generated update message to the input/output unit 203 via the mobile telephone 400 (step S209).

The control unit 402 of the mobile telephone 400 receives the update message from the memory card 200 via the input/output unit 401 (step S209), and the display unit 404 displays the update confirmation screen 432 (step S210). The control unit 402 receives an update instruction or a non-update instruction, as confirmation information, from the input unit 403 (step S211), and outputs the received update instruction or non-update instruction to the memory card 200 via the input/output unit 401 (step S212).

The control unit 202 of the memory card 200 receives the one of the update instruction and the non-update instruction from the mobile telephone 400 via the input/output unit 203 (step S212). When the received instruction is the non-update instruction (step S213), the control unit 202 ends the reservation change search end and moves control to step S173. When the received instruction is the update instruction (step S213), the control unit 202 performs reservation change processing in the following manner.

On receiving the update instruction (step S213), the control unit 202 controls the authentication unit 204 so as to perform mutual device authentication with the reservation center apparatus 300 via the input/output unit 203, the mobile telephone 400, the radio base station 11, the mobile telephone network 10 and the Internet 20, and the authentication unit 204 and the authentication unit 307 perform mutual device authentication (step S214).

When authentication succeeds (step S215), the control unit 202 generates train reservation change information composed of (i) a train reservation instruction indicating an instruction to change the reservation, (ii) a reservation number identifying the reservation information that is to be changed, and (iii) reservation signature data (step S217), and transmits the generated train reservation change information to the reservation center apparatus 300 via the input/output unit 203, the mobile telephone 400, the radio base station 11, the mobile telephone network 10 and the Internet 20 (steps S218 and S219).

When authentication with the memory card 200 succeeds (step S216), the control unit 310 of the reservation center apparatus 300 receives the train reservation change information from the memory card 200 via the mobile telephone 400, the radio base station 11, the mobile telephone network 10 and the Internet 20 (steps S218 and S219). The signature unit 309 performs verification of the reservation signature data (step S220), and when verification fails (step S221), the reservation center apparatus 300 stops processing. When verification succeeds (step S221), the control unit 310 reads, from the reservation user table 332, reservation user information corresponding to the received reservation number (included in the train reservation change information) (step S222), extracts the travel date and the train number from the read reservation user information, and reads the train service state information that includes the extracted travel date and train number, from the train service state information table 334. The control unit 310 then extracts the service state from the read train service state information (step S223), and judges whether the extracted service state is “normal service”, “delayed”, or “cancelled” (step S224).

(a) “Cancelled”

When the service state is judged to be “cancelled” (step S224), the control unit 310 transmits a message indicating the cancellation to the memory card 200 via the transmission/reception unit 308, the Internet 20, the mobile telephone network 10, the radio base station 11 and the mobile telephone 400 (step S231).

The control unit 402 of the mobile telephone 400 receives the message indicating the cancellation from the reservation center apparatus 300 via the Internet 20, the mobile telephone network 10, and the radio base station 11 (step S231). The display unit 404 displays the reservation change screen 435 (step S232), the input unit 403 receives an operation of the operation button 435a according to a user operation (step S233), and outputs a reservation change instruction indicating changing of the reservation, to the control unit 402. The control unit 402 outputs the received reservation change instruction to the reservation center apparatus 300 via the telephone communication unit 408, the antenna 413, the radio base station 11, the mobile telephone network 10 and the Internet 20 (step S234).

(b) “Delayed”

When the service state is judged to be “delayed” (step S224), the control unit 310 transmits a message indicating the delay to the memory card 200 via the transmission/reception unit 308, the Internet 20, the mobile telephone network 10, the radio base station 11 and the mobile telephone 400 (step S241).

Next, the control unit 402 of the mobile telephone 400 receives the message indicating the delay from the reservation center apparatus 300 via the Internet 20, the mobile telephone network 10, and the radio base station 11 (step S241). The display unit 404 displays the reservation change confirmation screen 436 (step S242), and the input unit 403 receives an operation of either the operation button 436b or the operation button 436c (step S243). The input unit 403 outputs a reservation change instruction indicating that the reservation is to be changed, or a reservation non-change instruction indicating that the reservation is not to be changed, to the control unit 402. The control unit 402 outputs the received one of the reservation change instruction and the reservation non-change instruction to the reservation center apparatus 300 via the telephone communication control unit 405, the telephone communication unit 408, the antenna 413, the radio base station 11, the mobile telephone network 10 and the Internet 20 (step S244).

The control unit 310 of the reservation center apparatus 300 receives the one of the reservation change instruction and the reservation non-change instruction from the memory card 200 via the mobile telephone 400, the radio base station 11, the mobile telephone network 10 and the Internet 20 (step S244). When the received instruction is the reservation non-change instruction (step S245), the control unit 310 ends processing without performing subsequent reservation change processing. When the received instruction is the reservation change instruction (step S245), the control unit 310 continues the reservation change processing as described in the following.

The search unit 305 generates train list screen information that includes information or one or more trains that fulfill the received search conditions, with use of the train reservation table 331 and the train service schedule information table 333 (step S251), and transmits the generated train list screen information to mobile telephone 400 via the transmission/reception unit 308 and the Internet 20 (step S252).

The control unit 402 of the mobile telephone 400 receives the train list screen information from the reservation center apparatus 300 via the Internet 20, the mobile telephone network 10, the radio base station 11, the antenna 413, the telephone communication unit 408, and the telephone communication control unit 405 (step S252), and the display unit 404 displays the train list screen (step S253). The input unit 403 receives a selection of one of the selection buttons according to a user operation, and the control unit 402 extracts the train number corresponding to the selection button of which the selection was received, generates train reservation conditions (step S255), and transmits the generated train reservation conditions to the reservation center apparatus 300 via the radio base station 11, the mobile telephone network 10 and the Internet 20 (step S255).

The control unit 310 receives the train reservation conditions from the mobile telephone 400 via the radio base station 11, the mobile telephone network 10, the Internet 20 and the transmission/reception unit 308 (step S255). The reservation processing unit 304 checks whether or not seat reservation information that fulfills the received train reservation conditions exists in the train reservation table 331 (step S256). When such information does not exist (step S257), the processing is repeated from step S251.

When section information that fulfills the received train search conditions exists in the train reservation table 331 (step S257), the reservation processing unit 304 selects one of the pieces of section information that fulfills the received train reservation conditions, and locks the selected section information in the train reservation table 331 (step S258). Next, the screen generation unit 306 receives the train service schedule information and the train reservation information from the reservation processing unit 304, reads confirmation screen information from the screen information storage unit 303, generates confirmation screen information for displaying the reservation confirmation screen 434, with use of the read confirmation screen information and the received train service schedule information and the train reservation information, and transmits the generated confirmation screen information to the mobile telephone 400 via the transmission/reception unit 308, the Internet 20, the mobile telephone network 10 and the radio base station 11 (step S259).

The control unit 402 of the mobile telephone 400 receives the confirmation screen information from the reservation center apparatus 300 via the Internet 20, the mobile telephone network 10 and the radio base station 11 (step S259), and generates the reservation confirmation screen 434 with use of the received confirmation screen information. The display unit 404 displays the reservation confirmation screen 434, the input unit 403 receives an operation of either the operation button 434b or the operation button 434c according to a user operation, and outputs the confirmation information indicating acceptance or non-acceptance, depending on which of the operation buttons 434b and 434c the operation was received for (step S260), and transmits the confirmation information to the reservation center apparatus 300 via the radio base station 11, the mobile telephone network 10 and the Internet 20 (step S261).

The control unit 310 of the reservation center apparatus 300 receives the confirmation information from the mobile telephone 400 via the radio base station 11, the mobile telephone network 10 and the Internet 20 (step S261). When the received confirmation information indicates non-acceptance (step S262), the control unit 310 stops the processing. When the confirmation information indicates acceptance (step S262), the reservation processing unit 304 deletes the reservation user information that is being updated from the reservation user table 332, rewrites the section information being updated in the train reservation table 311 to indicate “available” (step S263), and generates reservation information (step S264).

Next, the signature unit 309 reads the reservation center secret key from the key storage unit 302 (step S265), receives the reservation information from the reservation processing unit 304, applies a digital signature SIG to the received reservation information, with use of the received reservation center secret key, thereby generating reservation signature data, and outputs the generated reservation signature data to the reservation processing unit 304 (step S266). The reservation processing unit 304 receives the reservation signature data from the signature unit 309, and transmits the received reservation signature data and the generated reservation information to the memory card 200 via the transmission/reception unit 308, the Internet 20, the mobile telephone network 10, the radio base station 11 and the mobile telephone 400 (steps S267 and S268).

The input/output unit 203 receives the reservation signature data and reservation information (steps S267 and S268), deletes the old reservation information and the old signature data (step S269), and writes the received reservation signature data and reservation information to the general area 212 (step S270).

Meanwhile, the reservation processing unit 304 writes the reservation number to the locked section information (step S271), releases the lock (step S272), adds the user ID to the reservation information to generate reservation user information, and writes the generated reservation user information to the reservation user table 332 (step S273).

(c) “Normal Service”

When the service state is judged to be “normal service” (step S224), the processing from step S251 onwards is performed.

(3) Operations for Ticket Issuing

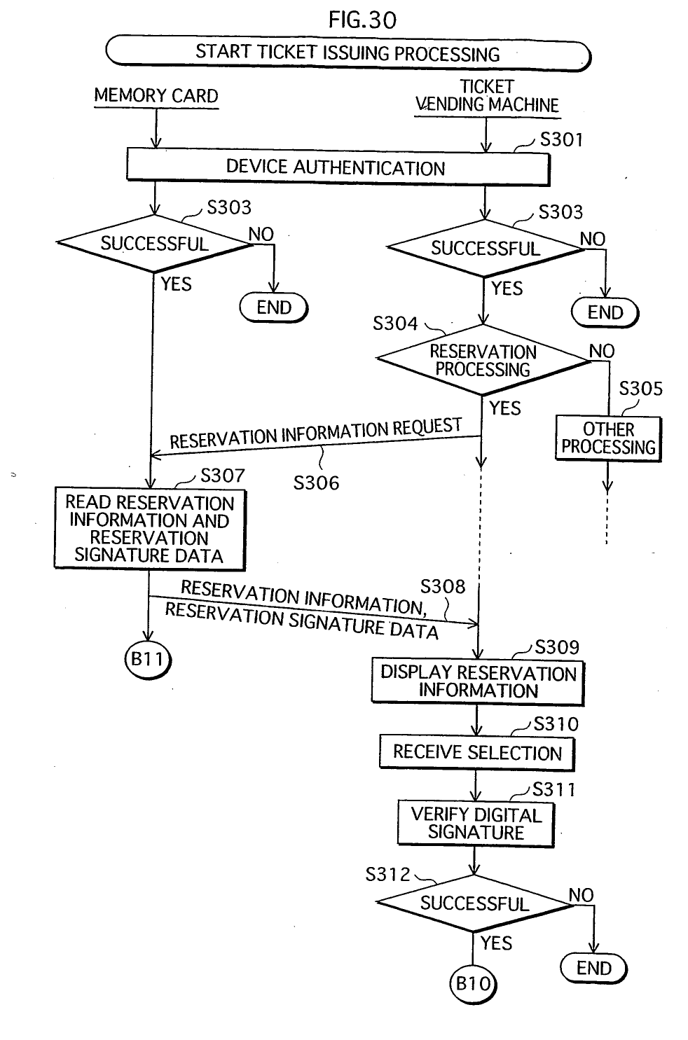

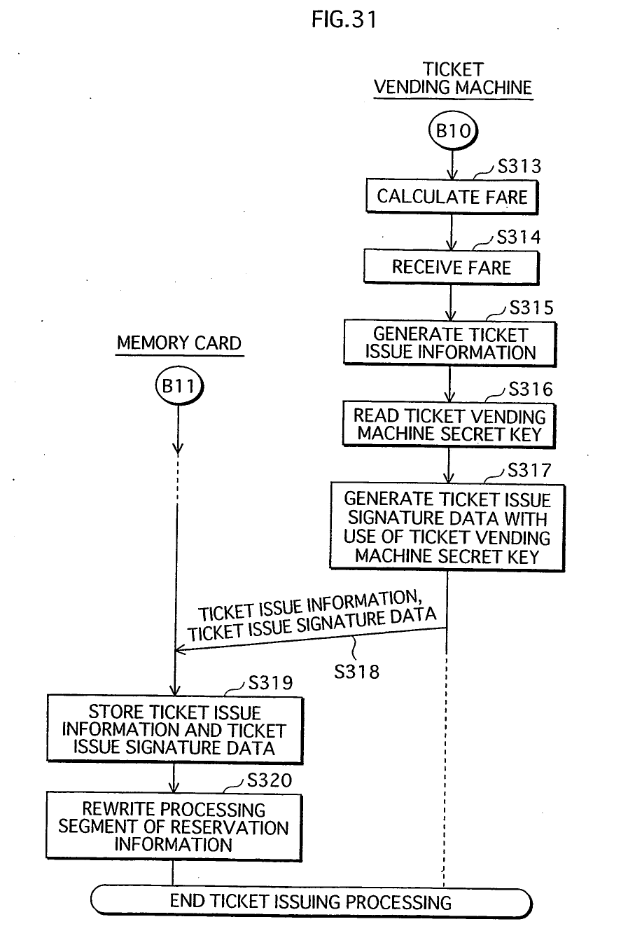

The following describes operations for ticket issuing in the transport ticket system 1, with use of the flowcharts in FIG. 30 and FIG. 31.

On the memory card 200 being inserted in the ticket vending machine 600 by the user, the authentication unit 608 of the ticket vending machine 600 and the authentication unit 204 of the memory card 200 perform mutual device authentication (step S301).

When device authentication with the memory card 200 fails (step S303), the ticket vending machine 600 ends the ticket issue processing. When device authentication with the memory card 200 succeeds (step S303), the control unit 606 receives instruction information corresponding to the button that has been operated from the input unit 603. When the received instruction information corresponds to a button other than the reserved ticket issue button (step S304), the control unit 606 performs corresponding processing (step S305).

When the instruction information received from the input unit 603 corresponds to the reserved ticket issue button (step S304), the control unit 606 outputs a reservation information request indicating a request for reservation information, to the memory card 200 via the input/output unit 607 (step S306).

When device-authentication is successful (step S302), the input/output unit 203 of the memory card 200 receives the reservation information request indicating a request for reservation information, from the ticket vending machine 600 (step S306), reads the reservation information table 232 from the general area 212 (step S307), and outputs the read reservation information table (which includes at least one set of reservation information and reservation signature data) to the ticket vending machine 600 (step S308). When device authentication fails (step S302), the memory card 200 stops subsequent processing.

Next, the control unit 606 of the ticket vending machine 600 receives the at least one set of reservation information and reservation signature data from the memory card 200 via the input/output unit 607 (step S308), and the display unit 604 displays the received reservation information (step S309). The control unit 606 receives a selection of one reservation information from the user from among the displayed at least one reservation information (step S310), and the signature processing unit 605 performs digital signature verification of the reservation signature data corresponding to the selected reservation information (step S311).

If digital signature verification fails (step S312), the control unit 606 stops processing with respect to the selected reservation information.

If digital signature verification succeeds (step S312), the control unit 606 calculates the fare with use of the selected reservation information and the fare table stored in the information storage unit 601 (step S313). The cash processing unit 609 receives cash equivalent to the fare (step S314), and the control unit 606 generates ticket issue information with use of the reservation information (step S315). The signature processing unit 605 reads the ticket vending machine secret key (step S316), applies a digital signature to the ticket issue information, based on the read ticket vending machine secret key, thereby generating ticket issue signature data (step S317), and the control unit 606 outputs the ticket issue information and the ticket issue signature data to the memory card 200 via the input/output unit 607 (step S318).

The input/output unit 203 of the memory card 200 receives the ticket issue information and the ticket issue signature data from the ticket vending machine 600 (step S318), writes the received ticket issue information and ticket issue signature data to the ticket issue information table 234 (step S319), and re-writes the processing segment in the reservation information corresponding to the received ticket issue information so as to indicate “processed” (step S320).

(4) Ticket Inspection Machine Operations

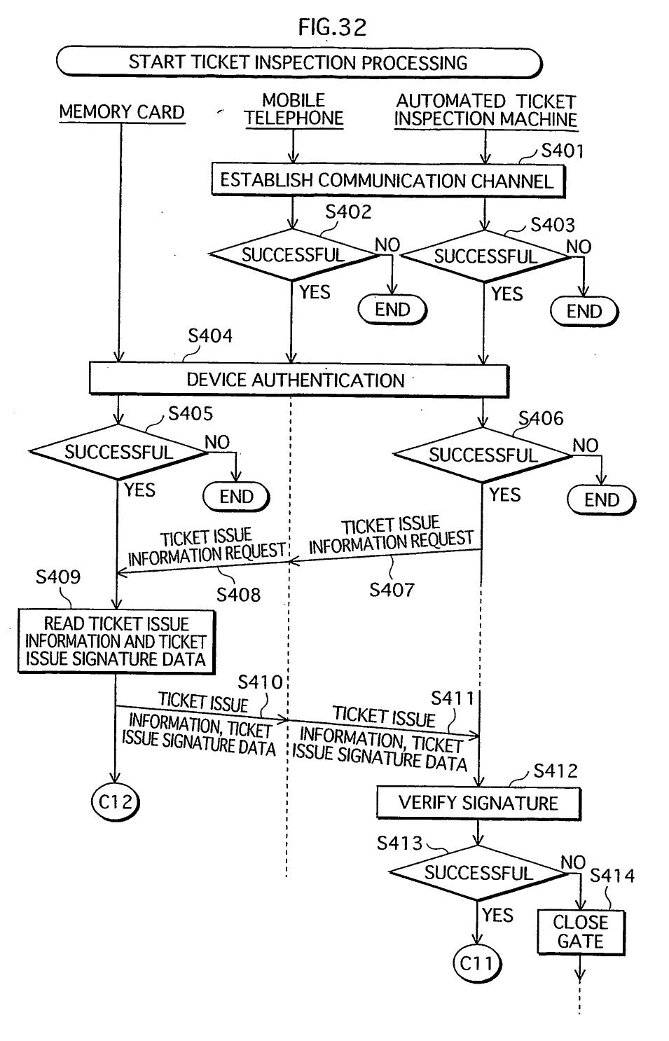

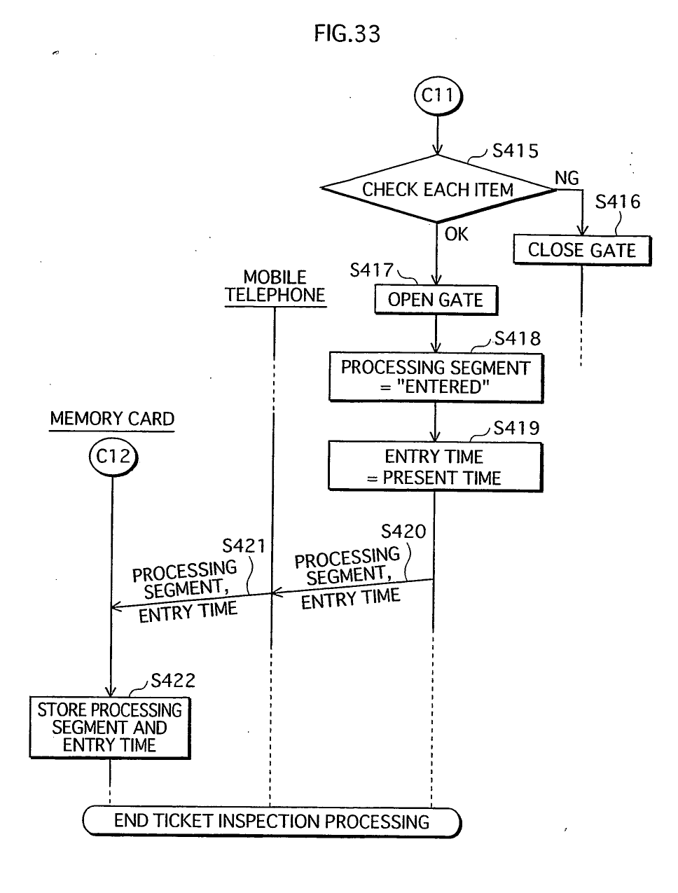

The following describes operations for ticket inspection machine in the travel ticket system 1, with use of the flowcharts in FIG. 32 and FIG. 33.

The short distance communication control unit 411 of the mobile telephone 400 and the short distance communication control unit 706 establish a communication channel for short distance radio communication (step S401).

When establishment of the communication channel fails (step S402), the mobile telephone 400 ends communication with the automated ticket inspection machine 700. Furthermore, when establishment of the communication channel fails (step S403), the automated ticket inspection machine 700 ends communication with the mobile telephone 400.

When the communication channel is established (steps S402 and S403), the authentication unit 204 of the memory card 200 and the authentication unit 714 of the automated ticket inspection machine 700 perform mutual device authentication via the mobile telephone 400 (step S404).

When authentication with the memory card 200 succeeds (step S406), the control unit 704 of the automated ticket inspection machine 700 requests ticket issue information from the memory card 200 via the mobile telephone 400 (steps S407 and S408), and when authentication with the automated ticket inspection machine 700 succeeds (step S405), the control unit 202 of the memory card 200 receives the request for the ticket issue information (steps S407 and S408). The input/output unit 203 reads the ticket issue information and ticket issue signature data from the ticket issue information table 234 in the general area 212 (step S409), and the control unit 202 outputs the read ticket issue information and ticket issue signature data to the automated ticket inspection machine 700 via the mobile telephone 400 (steps S410 and S411). The control unit 704 receives the ticket issue information and the ticket issue signature information from the memory card 200 via the mobile telephone 400 (steps S410 and S411), the signature processing unit 711 reads the ticket vending machine public key from the key storage unit 709, and applies digital signature verification to the received ticket issue signature data with use of the read ticket vending machine public key (step 412). When verification fails (step S413), the control unit 704 controls so that the gate 712 closes (step S414).

When verification succeeds (step S413), the ticket processing unit 703 inspects each item in the received ticket issue information under the control of the control unit 704, and if the ticket issue information does not pass the inspection (step S415), the control unit 704 controls so that the gate 712 closes (step S417). If the ticket issue information passes the check (step S415), the control unit 704 controls so that the gate 712 opens (step S417), generates a processing segment so as to indicate “entered” (step S418), generates an entry time which is the present time (step S419), and outputs the generated processing segment and entry time to the memory card 200 via the mobile telephone 400 (steps S420 and S421).

The input/output unit 203 of the memory card 200 receives the processing segment and the entry time from the automated ticket inspection machine 700 via the mobile telephone 400 (steps S420 and S421), and writes the received processing segment and entry time to the ticket issue information table 234 (step S422).

2. Modifications

Although the present invention has been described based on the above embodiments, the present invention is not limited to these embodiments. The following cases are included in the present invention.

(1) Although the transport ticket system 1 is for making and changing train reservations in the described embodiment, the transport ticket system 1 may instead be used by another organization that provides users with a transportation service with transport such as aeroplanes or boats, for making and changing reservations for such transport.

Furthermore, the present invention may be applied to movie reservations in a similar way to the transport ticket system 1. In such a case, movie reservations may be changed in the same way as the transport ticket system 1 with use of the movie start time and the expected arrival time at the movie theatre. Furthermore, the transport ticket system 1 may be applied to concerts, musicals, vaudeville theatre, plays, kabuki, baseball, or the like.

In addition, the present invention may be applied to reservations for purchase of fresh food in a similar way to the transport ticket system 1. In this case, reservations may be changed based on weather information provided by a government meteorological bureau, or by a private weather business company.

As one example, a personal computer (corresponding to the personal computer 100 in the transport ticket system 1) is located in a retail shop such as a convenience store, and a memory card (corresponding to the memory card 200 in the transport ticket system 1) is mounted in the personal computer. A reservation center apparatus (equivalent o the reservation center apparatus 300 in the transport ticket system 1) is located at an ice cream manufacturer that produces and supplies ice cream to the convenience store. Furthermore, a weather information server apparatus (corresponding to the timetable server apparatus 500 in the transport ticket system 1) is located at the weather business company. The personal computer is connected to the reservation center apparatus and the weather information server apparatus via the Internet.

Suppose that, according to operations by the manager of the convenience store, on August 1 the personal computer makes a reservation with the reservation center apparatus for 100 ice creams scheduled to be sold on August 3. The personal computer writes reservation information indicating the reservation for purchasing 100 ice creams to the memory card. Here, the reservation information includes a delivery date “August 3”.

On August 2, the personal computer obtains weather forecast information for August 3 from the weather information server apparatus. According to the weather forecast information, the weather will be sunny with a temperature of 35° C. The personal computer judges whether the temperature is 30° C. or higher, 25° C. or higher and below 30° C., or below 25° C. When the temperature is 30° C. or higher, the personal computer updates the reservation with the reservation center apparatus, increasing the number of reserved ice creams from 100 to 150. When the temperature is 25° C. or higher and below 30 C, the personal computer does not perform reservation updating. When the temperature is below 25° C., the personal computer the personal computer updates the reservation with the reservation center apparatus, reducing the number of reserved ice creams from 100 to 50.

In this way, the present invention can be applied to reservations for purchase (sales) of products, and reservations for being rendered with (providing) a service. Note that in the present specification, selling (purchasing) of a product incorporates the concept of providing (being rendered with) a service.

(2) Although GPS is used to determine the present location in the described embodiment, other means may be used for this purpose. For example, the mobile telephone may determine its present location with use of information indicating a cell in which the mobile telephone is presently located, or with use of information indicating a radio base station with which mobile telephone is presently able to communicate.

(3) Although the memory card makes an inquiry to the timetable server apparatus about the distance between the present location and the boarding station in the embodiment, the memory card may instead store internally the station information table shown in FIG. 16, and calculate the distance using the stored station information table in the same way as the timetable server.

Since the storage area of the memory card is limited, there are cases in which the storage area is unable to store a table identical to the station information table held by the timetable server apparatus. In such a case, before the user departs for travel, the personal computer may be used to extract station information that includes stations in the area that the user will visit from the station information table of timetable server before the user departs for travel, and write the extracted station information to the memory card as a station information table.

(4) Although the memory card makes an inquiry to the timetable server apparatus about the expected arrival time at the boarding station in the embodiment, the memory card may instead store the inter-station timetable shown in FIG. 17, and calculate the expected arrival time.

Since the storage area of the memory card is limited, as described above, there are cases in which the storage area is unable to store a table identical to the inter-station timetable held by the timetable server apparatus. In such a case, before the user departs for travel, the personal computer may be used to extract station information that includes stations in the area that the user will visit from the station information table of timetable server before the user departs for travel, and write the extracted station information to the memory card as an inter-station timetable.

(5) In the embodiment, the timetable server apparatus may store map information of various regions, and when changing reservation information, the mobile telephone may obtain map information indicating a route to the boarding station from the present location, and display the obtained map information.

Furthermore, before the user departs for travel, the personal computer may be used to extract map information that includes the region that the user will visit from the map information held by the timetable server apparatus, and write the extracted map information to the memory card. When changing reservation information, the mobile telephone obtained map information indicating the route from the present location to the boarding station, from the memory card, and displays the obtains map information.

(6) In the embodiment, the personal computer or the mobile telephone, when making or changing a reservation, receives train list screen information from the reservation center apparatus, and selects one train therefrom. However, as an alternative structure, the memory card may store a train timetable, and the personal computer or the mobile telephone may select a train from the train timetable stored by the memory card.

Furthermore, before the user departs for travel, the personal computer may be used to obtain a train timetable for the travel period from the reservation center apparatus and write the obtained train timetable to the memory card. The train timetable written to the memory card may be used in the manner described above.

(7) In the embodiment, when purchasing a ticket using the reservation information, the user inserts the memory card in the ticket vending machine, and the ticket vending machine reads the reservation information from the memory card, generates ticket issue information, and writes the generated ticket issue information to the memory card. The following is an alternative structure.

Similar to the automated ticket inspection machine, the ticket vending machine includes a short distance communication control unit, a short distance communication unit and an antenna to enable short distance radio communication with the mobile telephone. According to radio communication by the ticket vending machine and the memory card via the mobile telephone, the ticket vending machine obtains reservation information from the mobile telephone, generates ticket issue information, and outputs the generated ticket issue information to the memory card.

(8) In the embodiment, the user insets the memory card in the ticket vending machine when purchasing a ticket using reservation information, and pays cash for the fare calculated by the ticket vending machine. The following is an alternative structure.

The memory card stores electronic money information that is used instead of cash, in advance in the secure area, and payment for the fare is settled between the ticket vending machine and the memory card using the electronic money.

(9) The following is a possible structure.

The memory card stores electronic money information that is used instead of cash, in advance in the secure area.

The user passes between the automated ticket inspection machines 700 and 751 while holding the mobile telephone in which the memory card is inserted.

The automated ticket inspection machine 700 obtains reservation information from the memory card via the mobile telephone according to short distance communication, and inspects the content of the obtained reservation information. Here, the examination is the same as described for the ticket processing unit 703. If the reservation information passes the inspection, the automated ticket inspection machine 700 generates ticket issue information using the obtained reservation information in the same way as the ticket vending machine, outputs the generated ticket issue information to the memory card. At this time the automated ticket machine and the memory card also settle payment for the fare using the electronic money. When the amount of electronic money indicated by the electronic money information is less than the amount of the fare, the automated ticket inspection machine 700 displays information to that effect, and closes the gate.

Furthermore, if the reservation information does not pass the inspection, the automated ticket inspection machine 700 displays information to that effect, and closes the gate.

(10) The reservation information table and the ticket issue information table may be stored is a storage unit formed by a tamper-resistant module in the memory card.

(11) The memory card may include a credit card function.

(12) The transport ticket system 1 may include a mobile information terminal instead of the mobile telephone 400 in the embodiment. Here, the mobile information terminal has a similar structure to the mobile telephone 400, and further includes functions such as schedule management, address book management, hand written character input, memo, dictionary search in various dictionaries such as a Japanese dictionary, a kanji (Chinese character)-Japanese dictionary and an English-Japanese dictionary, spreadsheet, and calculator.

(13) Instead of the memory card 200 in the embodiment, the mobile telephone may perform processing for reservation change searches and related processing. Specifically, the mobile telephone may perform the operations shown by steps S172-S177, S179, S183, S184, S188, S191-S196, S201-S202, S206-S209, S212-S215, and S217-S218.

(14) In the embodiment, the memory card 200 may judge whether to switch a reservation and warn the user, based on the information indicating the present location obtained from the GPS via the mobile telephone 400.

Specifically, the memory card 200 further compares the departure time in the reservation information in the reservation information table 232 with the present time, and while the present time is between 3 hours and 30 minutes before the departure time, every 5 minutes the memory card 200 obtains a present location from GPS via the mobile telephone 400, and writes each set of the obtained present location and present time in correspondence to the general area 212 in the order in which they were obtained.

Furthermore, while the present time is between 3 hours and 30 minutes before the departure time, every 5 minutes the memory card 200 extracts each set of a present location and a present time that fall within the last 30 minutes from the general area 212, and judges whether a change has occurred in the present location between the extracted sets. When it is judged that a change has not occurred, it is assumed that the user is working or resting in a particular, fixed place, and therefore assumed that the user will require some time before setting out for travel.

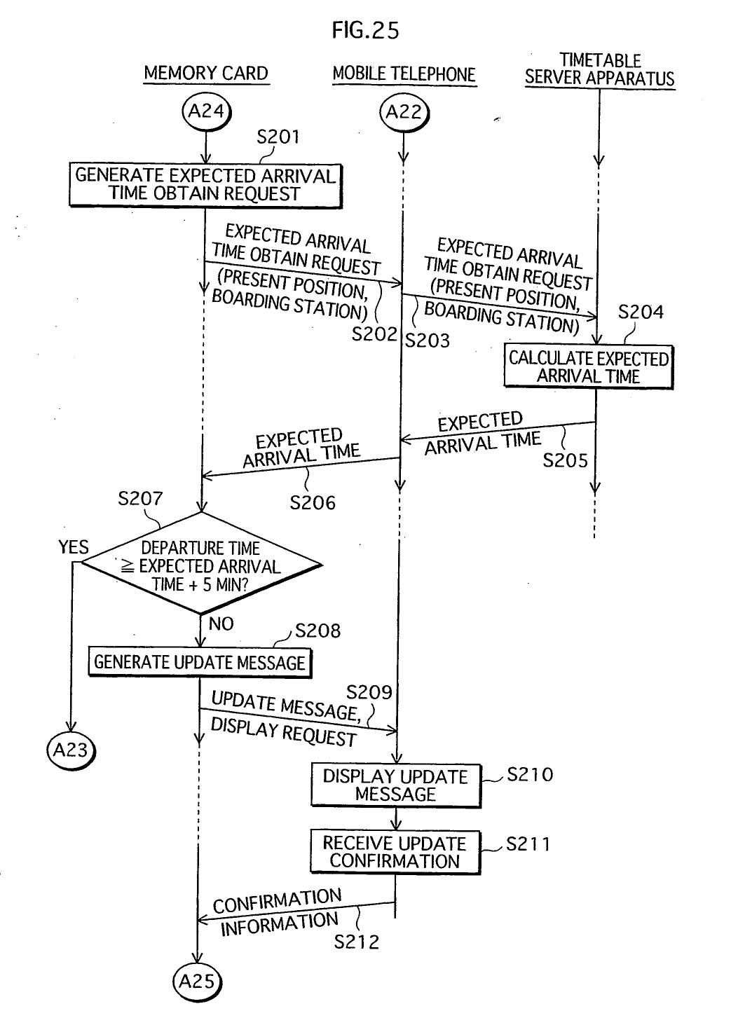

When it is judged that a change has not occurred, in other words, when it is thought that the user is in a particular, fixed place and when the departure time is less than the expected time at step S207 in FIG. 25 (NO at step S207), the memory card 200 outputs the update message to the mobile telephone 400 which displays the update message, and also outputs a message encouraging the user to set out for travel as soon as possible to the mobile telephone 400 which displays the message.

Here, the memory card 200 may further output, to the mobile telephone 400, a vibration instruction for having a vibrator of the mobile telephone 400 vibrate as a warning to the user. On receiving the vibrate instruction, the vibrator of the mobile telephone 400 may begin to vibrate. Furthermore, the memory card 200 may control the mobile telephone 400 so as to output a warning sound as a warning to the user.

Furthermore, when it is judged that a change has not occurred, in other words, when it is thought that the user is in a particular, fixed place, instead of comparing the departure time with an expected time obtained by adding 5 minutes to the received expected arrival time (step S207), the memory card 200 may compare the departure time with an expected time obtained by adding 20 minutes to the received expected arrival time. This enables the memory card 200 to issue an early warning to the user.

Note that in the above, the memory card 200 obtains the present location from the GPS via the mobile telephone 400 every 5 minutes when the present time is between 3 hours and 30 minutes before the departure time because it is thought that it is effective to warn the user during a time period that is close to the departure time, such as when the present time is between 30 minutes and 3 hours before the departure time. However, the described operations are not limited to being performed between 3 hours and 30 minutes. For example, the operations may be performed between 6 hours and 30 minutes, or may be performed without such a limit on the time span.

Furthermore, the memory card 200 extracts sets of the present location and the present time for the last 30 minutes written to the general area 212, every 5 minutes while the present time is between 3 hours and 30 minutes before the departure time. When the memory card 200 judges that a change has occurred in the present location in the extracted sets, the memory card 200 calculates the speed at which the user is moving, using the sets, and:

(i) if the calculated movement speed is less than 5 Km/hour, instead of comparing the departure time with an expected time obtained by adding 20 minutes to the expected arrival time, the memory card 200 compares the departure time with an expected time obtained by adding 40 minutes to the expected arrival time;

(ii) if the calculated movement speed is 5 Km/hour or greater and less than 20 Km/hour, instead of comparing the departure time with an expected time obtained by adding 20 minutes to the expected arrival time, the memory card 200 compares the departure time with an expected time obtained by adding 30 minutes to the expected arrival time;

(iii) if the calculated movement speed is 20 Km/hour or greater and less than 40 Km/hour, compares the departure time with an expected time obtained by adding 20 minutes to the expected arrival time, as described above; and

(iv) if the calculated movement speed is 40 Km/hour or greater, instead of comparing the departure time with an expected time obtained by adding 20 minutes to the expected arrival time, the memory card 200 compares the departure time with an expected time obtained by adding 5 minutes to the expected arrival time.

In this way, the margin of time may be changed when warning the user, depending on the speed at which the user is moving. The time margin is relatively low when the movement speed is fast, and the time margin is relatively high when the movement speed is slow.

Furthermore, the memory card 200 may store the movement speed of the user calculated as described in the general area 212 as user characteristic data, and use movement speeds stored in the past in the above-described cases.

Here, if the calculated movement speed is 5 Km/hour, this movement speed is recorded as a walking speed of the user. Furthermore, if the obtained speed is 5 Km/hour or greater and less than 20 Km/hour, this movement speed is recorded as a speed for when the user uses a bicycle. In this way, the movement speed and the movement means may be stored in combination depending on the movement speed.

Furthermore, the memory card 200 may use the stored movement speeds to calculate the amount of time required for the user to walk from the present location to the nearest station.

(15) Although the transport ticket system 1 shown in FIG. 1 includes the memory card 200 and the mobile telephone 400, the transport ticket system 1 may instead include a mobile telephone in which the memory card is incorporated.

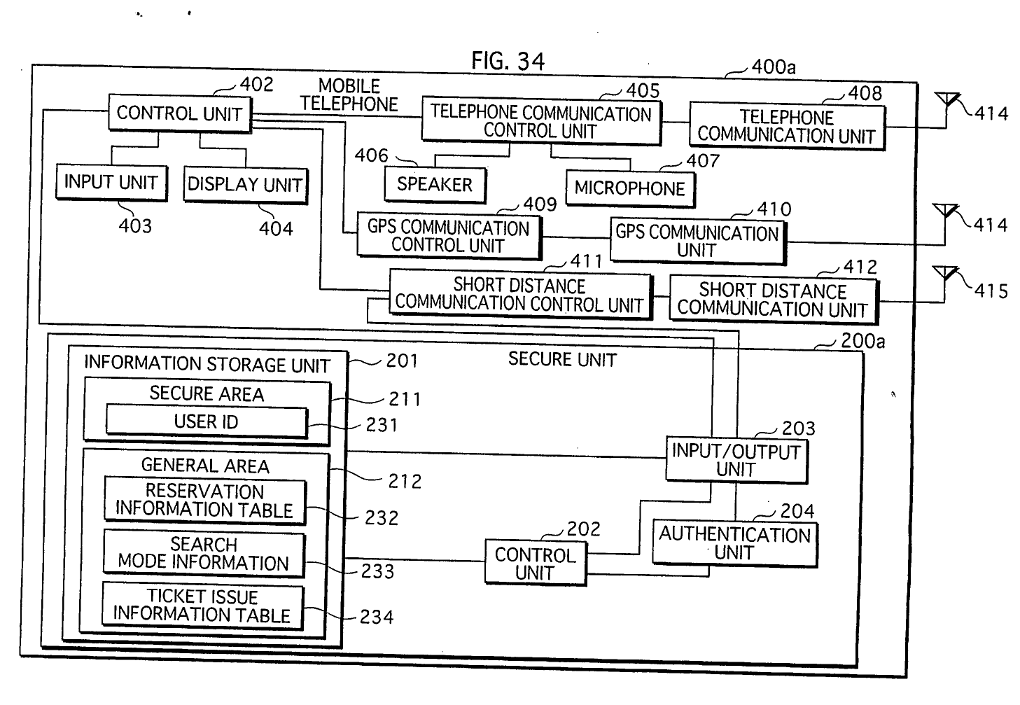

Specifically, as shown in FIG. 34, a mobile telephone 400a may be composed of the control unit 402, the input unit 403, the display unit 404, the telephone communication control unit 405, the telephone communication unit 408, the speaker 406, the microphone 407, the GPS communication control unit 409, the GPS communication unit 410, the short distance communication control unit 411, the short distance communication unit 412, the antenna 413, the antenna 414, the antenna 415, and a secure unit 200a. The secure unit 200a is composed of the information storage unit 201, control unit 202, input/output unit 203, and the authentication unit 204. The secure unit 200a is structured so as to be inaccessible from outside.

The control unit 402, the input unit 403, the display unit 404, the telephone communication control unit 405, the telephone communication unit 408, the speaker 406, the microphone 407, the GPS communication unit 410, the short distance communication control unit 411, the short distance communication unit 412, the antenna 413, the antenna 414 and the antenna 415 are identical to the compositional elements of the mobile telephone 400. The information storage unit 201, the control unit 202, the input/output unit 203 and the authentication unit 204 are identical to the compositional elements of the memory card 200.

(16) Although the transport ticket system 1 shown in FIG. 1 is composed of the memory card 200 and the mobile telephone 400, part of the memory card may be incorporated in the mobile telephone.

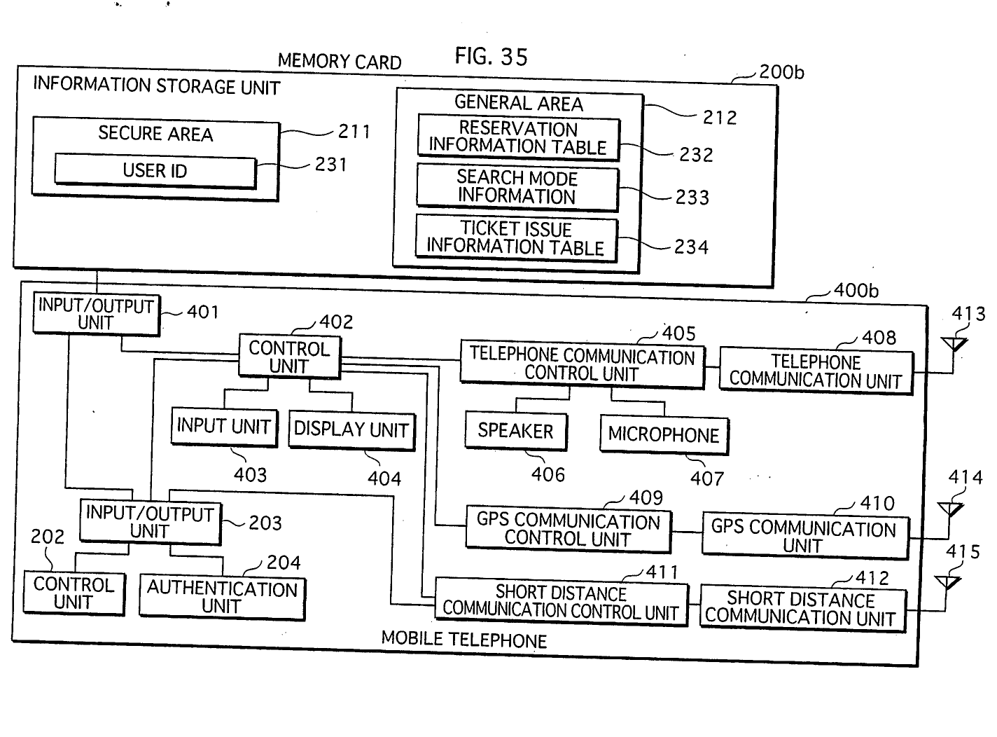

Specifically, a mobile telephone 400b, as shown in FIG. 35, is composed of an input/output unit 401, a control unit 402, an input unit 403, a display unit 404, a telephone communication control unit 405, a telephone communication unit 408, a speaker 406, a microphone 407, a GPS communication control unit 409, a GPS communication unit 410, a short distance communication control unit 411, a short distance communication unit 412, an antenna 413, an antenna 414, an antenna 415, a control unit 202, a input/output unit 203 and a authentication unit 204. Furthermore, a memory card 200b includes an information storage unit 201 which is composed of a secure area 211 and a general area 212.

The input/output unit 401, the control unit 402, the input unit 403, the display unit 404, the telephone communication control unit 405, the telephone communication unit 408, the speaker 406, the microphone 407, the GPS communication control unit 409, the GPS communication unit 410, the short distance communication control unit 411, the short distance communication unit 412, the antenna 413, the antenna 414, and the antenna 415 have the same structure as the structural components of the mobile telephone 400, and the information storage unit 201, the control unit 202, the input/output unit 203, and the authentication unit 204 have the same structure as the structural components of the memory card 200.

(17) The information storage unit 501, the service processing unit 502, and the control unit 505 in the timetable server apparatus 500 in the embodiment may instead be incorporated in the mobile telephone 400. In such a case, the memory card 200, in the manner described earlier, obtains the distance from the present location of the mobile telephone 400 to the boarding station at which the train for which the reservation has been made is to be boarded, from the mobile telephone 400 in which the function and structure of the timetable server apparatus 500 are incorporated.

(18) The embodiment is not limited to the structure in which, as shown at steps S204 to S207 in FIG. 25, the timetable server apparatus 500 calculates the expected arrival time, transmits the calculated expected arrival time to the memory card 200 via the Internet 20, the mobile telephone network 10, the radio base station 11, and the mobile telephone 400, and the memory card 200 receives the expected arrival time, and compares the departure time with the expected time obtained by adding five minutes to the received expected arrival time. The following is an alternative.

The control unit 505 of the time table server apparatus 500 extracts the approximate time required between the station identified by the extracted station name and the received boarding station from the inter-station timetable 532, and transmits the extracted required time to the memory card 200 via the transmission/reception unit 506, the Internet 20, the mobile telephone network 10, the radio base station 11 and the mobile telephone 400.

The control unit 202 of the memory card 200 receives the required time from the timetable server apparatus 500 via the Internet 20, the mobile telephone network 10, the radio base station 11, and the mobile telephone 400, and calculates an expected arrival time which is the received expected time added to the present time. Then the control unit 202 compares the departure time with an expected time obtained by adding five minutes to the calculated expected arrival time.

(19) The present invention is a reservation changing system for changing a reservation for purchase of a product, including: a storage unit operable to store reservation information that indicates a reservation for purchase of a product; an obtaining unit operable to obtain prediction information that indicates predicted use of the product after purchase; a judgment unit operable to judge whether or not to change the reservation information, based on the stored reservation information and the obtained prediction information; and a changing unit operable to replace the reservation information with other reservation information when the judgment unit judges that the reservation information is to be changed.

According to the stated structure, a judgment can be made as to whether or not to change the reservation information, based on the reservation information that indicates a reservation for purchase of a product, and the prediction information that indicates predicted use of the product after purchase, and therefore the judgment can be made reliably.

Here, the product is a ticket for a transport that provides a transportation service, the storage unit stores the reservation information that indicates a reservation for purchase of the ticket, the reservation information includes a boarding location at which the transport is boarded and a departure time of the transport, the obtaining unit obtains, as the prediction information, an expected arrival time of a user at the boarding location, the judgment unit compares the obtained expected arrival time with the departure time included in the reservation information, and when the expected arrival time is later than the departure time, judges that the reservation information is to be changed, and the changing unit replaces the reservation information with the other reservation information that indicates a reservation for a ticket for another transport that departs after the arrival time.

According to the stated structure, the expected arrival time included in the obtained prediction information is compared with the departure time included in the reservation information, and when the expected arrival time is later than the departure time, it is judged that the reservation information is to be changed. Therefore, the judgment can be made reliably.

Furthermore, the present invention is a reservation changing system for changing a reservation for purchase of a ticket for a transport that provides a transportation service, including a portable IC card, a mobile terminal apparatus, an information provision server apparatus and a reservation server apparatus, the IC card being mounted in the mobile telephone terminal apparatus, the mobile terminal apparatus being connected to the information provision server apparatus and the reservation server apparatus via a network, wherein the IC card stores reservation information that indicates a reservation for purchase of a ticket, the reservation information including a boarding location at which the transport is to be boarded and a departure time of the transport, the mobile terminal apparatus calculates a present location based on a range finding signals received from a plurality of GPS satellites, extracts the boarding location from the reservation information stored in the mounted IC card, and transmits the calculated present location and the extracted boarding location to the information provision server apparatus, the information provision server apparatus receives the present location and the boarding location, calculates, with use of the received present location and boarding location, an expected arrival time at the boarding location, and transmits the calculated expected arrival time to the mobile terminal apparatus, the mobile terminal apparatus receives the expected arrival time and outputs the received expected arrival time to he IC card, the IC card receives the expected arrival time, compares the received expected arrival time with the departure time included in the reservation information, and when the expected arrival time is after the departure time, judges that the reservation information is to be changed, transmits, via the mobile terminal apparatus, other reservation information to the reservation server apparatus in order to make a reservation, the other reservation information indicating a reservation for a ticket for another transport that departs after the departure time, and overwrites the reservation information with the other reservation information, and the reservation server apparatus receives the other reservation information, and an makes a reservation according to the received other reservation information, in place of the reservation information.

According to the stated structure, the IC card receives the expected arrival time, compares the received expected arrival time with the departure time included in the reservation information, and when the expected arrival time is later than the departure time, judges that the reservation information is to be changed, and transmits, via the mobile terminal apparatus, other reservation information that indicates a reservation for a ticket for another transport that departs after the departure time, thereby making a reservation. Therefore, the judgment and the change of reservation can be performed reliably.

Furthermore, the present invention is a portable IC card, including: a storage unit operable to store reservation information that indicates a reservation for purchase of a product; an obtaining unit operable to obtain prediction information that indicates predicted use of the product after purchase; a judgment unit operable to judge whether or not to change the reservation information, based on the stored reservation information and the obtained prediction information; and a changing unit operable to replace the reservation information with other reservation information when the judgment unit judges that the reservation information is to be changed.

According to the stated structure, the IC card judges whether or not to change the reservation information, based on the stored reservation information and the obtained prediction information, and therefore the judgment is made reliably.

Here, the product is a ticket for a transport that provides a transportation service, the storage unit stores the reservation information that indicates a reservation for purchase of the ticket, the reservation information includes a boarding location at which the transport is boarded and a departure time of the transport, the obtaining unit obtains, as the prediction information, an expected arrival time of a user at the boarding location, the judgment unit compares the obtained expected arrival time with the departure time included in the reservation information, and when the expected arrival time is later than the departure time, judges that the reservation information is to be changed, and the changing unit makes a reservation according to the reservation information with the other reservation information that indicates a reservation for a ticket for another transport that departs after the arrival time, and overwrites the reservation information with the other reservation information.

According to the stated structure, the obtained expected arrival time is compared with the departure time included in the reservation information, and when the expected arrival time is later than the departure time, judges that the reservation information is to be changed. Therefore, the judgment is made reliably.

Here, the IC card is mounted in the mobile terminal apparatus, the mobile terminal apparatus is connected to the information provision server apparatus and the reservation server apparatus via a network, the obtaining unit instructs the mobile terminal apparatus to obtain a present location, the mobile terminal apparatus calculates the present location based on range finding signals received from a plurality of GPS satellites, extracts the boarding location from the reservation information stored in the mounted IC card, transmits the calculated present location and the extracted boarding location to the information provision server apparatus, the information provision server apparatus receives the present location and the boarding location, calculates an expected arrival time at the boarding location with use of the received present location and boarding location, and transmits the calculated expected arrival time to the mobile terminal apparatus, the mobile terminal apparatus receives the expected arrival time and outputs the received expected arrival time to the IC card, the obtaining unit receives the expected arrival time, the changing unit transmits, via the mobile terminal apparatus, the other reservation information that indicates a reservation for a ticket for another transport that departs after the departure time, thereby making a reservation and overwrites the reservation information with the other reservation information, and the reservation server apparatus receives the other reservation information, the makes a reservation according to the received other reservation information, in place of the reservation information.

According to the stated structure, the mobile terminal apparatus calculates the present location based on the range finding signals received from a plurality of GPS satellites, extracts the boarding distance from the reservation information stored on the IC card, and transmits the calculated present location and the extracted boarding location to the information provision server apparatus, and the information provision server apparatus calculates an expected arrival time at the boarding location with use of the received present location and boarding location, and transmits the calculated predicted arrival time to the IC card. Therefore, the IC card is able to obtain the predicted arrival time reliably.

Here, the IC card further includes: a present location obtaining unit operable to obtain a time difference between the departure time and a present time, and obtain a distance between the obtain present location and boarding location, and a decision unit operable to decide, according to the obtained time difference and the obtained distance, whether the judgment unit is to perform a judgment, wherein when the deciding unit decides that the judgment unit is not to perform the judgment, the judgment unit suppresses performing the judgment and the changing unit suppressing replacing.

According to the stated structure, the IC card further obtains the difference between the departure time and the present time, and the distance between the obtained present location and boarding location, and decides whether or not the judgment unit is to make the judgment, according to the obtained time difference and the obtained distance. Therefore, the judgment by the judgment unit can be made at an appropriate time.

Furthermore, present invention is a mobile terminal apparatus in which an IC card is mounted, the IC card storing therein reservation information that indicates a reservation for purchasing a product, the mobile terminal apparatus including: an obtaining unit operable to obtain prediction information that indicates a prediction for use of the product after purchase; a judgment unit operable to judge, based on the reservation information stored in the IC card and the prediction information, whether or not to change the reservation information; and a changing unit operable to, when the judgment unit judges that the reservation information is to be changed, make a reservation according to other reservation information in place of the reservation information, and replace the reservation information stored in the IC card with the other reservation information.

According to the stated structure, the mobile terminal judges whether or not to change the stored reservation information, based on stored the reservation information and the obtained prediction information. Therefore, the judgment can be made reliably.

Here, the product is a ticket for a transport that provides a transportation service, the IC card stores the reservation information that indicates a reservation for purchase of the ticket, the reservation information includes a boarding location at which the transport is boarded and a departure time of the transport, the obtaining unit obtains, as the prediction information, an expected arrival time of a user at the boarding location, the judgment unit compares the obtained expected arrival time with the departure time included in the reservation information, and when the expected arrival time is later than the departure time, judges that the reservation information is to be changed, and the changing unit makes a reservation according to the reservation information with the other reservation information that indicates a reservation for a ticket for another transport that departs after the arrival time, and overwrites the reservation information with the other reservation information.

According to the stated structure, the obtained expected arrival time is compared with the departure time included in the reservation information, and when the expected arrival time is after the departure time, it is judged that the reservation is to be changed. Therefore, the judgment is made reliably.

Here, the mobile terminal apparatus is connected to an information provision server apparatus and a reservation server apparatus, the obtaining unit calculates a present location based on range finding signals received from a plurality of GPS satellites, extracts the boarding location from the reservation information stored in the mounted IC card, and transmits the calculated present location and the extracted boarding location to the information provision server apparatus, the information provision service apparatus receives the present location and the boarding location, calculates the expected arrival time to the boarding location using the received present location and boarding location, and transmits the calculated expected arrival time to the mobile terminal apparatus, the obtaining unit receives the expected arrival time, the changing unit transmits, to the reservation server apparatus, other reservation information that indicates a reservation for a ticket for another transport that departs after the departure time, thereby making a reservation, and overwrites the reservation information with the other reservation information, and the reservation server apparatus receives the other reservation information, and makes a reservation according to the received other reservation information, in place of the reservation information.

According to the stated structure, the mobile terminal apparatus calculates the present location based on the range finding signal received from the plurality of GPS satellites, extracts the boarding location from the reservation information stored in the IC card, and transmits the calculated present location and the extracted boarding location to the information provision server apparatus, and the information provision server apparatus calculates the expected arrival time at the boarding location using the received present location and boarding location. Therefore, the mobile terminal apparatus is able to obtain the expected arrival time reliably.

(20) The present invention may be methods shown by the above. Furthermore, the methods may be a computer program realized by a computer, and may be a digital signal of the computer program.

Furthermore, the present invention may be a computer-readable recording medium such as a flexible disc, a hard disc, a CD-ROM, an MO, a DVD, a DVD-ROM, a DVD-RAM, a BD (Blu-Ray Disc), or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(21) The present invention may be any combination of the embodiments and modifications.

### INDUSTRIAL APPLICABILITY

As has been described, the present invention can be used in industries in which products are sold or in which services are provided, such as reserving and selling of goods in a retail shop, reserving and selling of tickets in a transport organization, and reserving and selling of tickets for plays and sport. Furthermore, reservations, or change or reservations, for purchase of a production or reception of a service by a user can be performed repeatedly and continuously. Consequently, the present invention can be used beneficially in industries.

1. A reservation changing system for changing a reservation for purchasing a ticket for transport that provides a transportation service, the reservation changing system comprising a mobile terminal apparatus, an information provision server apparatus, and a reservation server apparatus, wherein
the mobile terminal apparatus includes a secure unit, stores, in the secure unit, first reservation information indicating the reservation and including a boarding location where the transport is to be boarded and a departure time of the transport, obtains a present location of the mobile terminal apparatus, extracts the boarding location from the first reservation information, and transmits the obtained present location and the extracted boarding location to the information provision server apparatus,
the information provision server apparatus receives the present location and the boarding location, obtains, with use of the received present location and boarding location, an expected arrival time of a user at the boarding location or an approximate time for the user to arrive at the boarding location, and transmits the obtained expected arrival time or approximate time to the mobile terminal apparatus,
the mobile terminal apparatus, in the secure unit, receives the expected arrival time, or receives the approximate time and calculates an expected arrival time, and, when a time margin between the expected arrival time and the departure time included in the first reservation information is insufficient, transmits, to the reservation server apparatus, second reservation information indicating a reservation for a ticket for a transport that departs later than the departure time, and stores the second reservation information in place of the first reservation information, and
the reservation server apparatus receives the second reservation information, and stores the received second reservation information in place of the first reservation information.

2. The reservation changing system of claim 1, wherein
the mobile terminal apparatus determines that the time margin is insufficient when a margin-added expected arrival time is later than the departure time, the margin-added expected arrival time having been obtained by adding a margin value to the expected arrival time.

3. The reservation changing system of claim 2, wherein
the secure unit of the mobile communication terminal is a portable IC card.

4. The reservation changing system of claim 2, wherein
the secure unit of the mobile terminal apparatus performs communication with the information provision server apparatus and with the reservation server apparatus via a first communication interface, and
the secure unit of the mobile terminal apparatus further performs, with an external apparatus via a second communication interface, a procedure for boarding transport, with use of the stored second reservation information.

5. The reservation changing system of claim 4, wherein
the external apparatus is a ticket issuing apparatus that issues tickets for transport,
the secure unit of the mobile terminal apparatus outputs the stored second reservation information to the ticket issuing apparatus, and
the ticket issuing apparatus receives the second reservation information, and issues a ticket for the transport for which the reservation has been made according to the received second reservation information.

6. The reservation changing system of claim 4, wherein
the external apparatus is a ticket inspection apparatus that inspects tickets at an entry point for boarding transport,
the secure area of the mobile terminal apparatus outputs the stored second reservation information to the ticket inspection apparatus, and
the ticket inspection apparatus receives the second reservation information, inspects content of the received second reservation information, and controls opening and closing of a gate of the ticket inspection apparatus according to a result of the inspection.

7. A portable IC card, comprising:
a storage unit operable to store first reservation information, the first reservation information indicating a reservation for purchase of a ticket for a transport and including a boarding location where the transport is to be boarded and a departure time of the transport;
an obtaining unit operable to obtain an expected arrival time of a user at the boarding location;
a margin judgment unit operable to judge whether or not a time margin between the obtained expected arrival time and the departure time included in the first reservation information is sufficient; and
a changing unit operable to, when the time margin is judged not to be sufficient, store second reservation information in place of the first reservation information, the second reservation information indicating a reservation for a ticket for a transport that departs later than the departure time.

8. The IC card of claim 7, wherein
the margin judgment unit determines that the time margin is insufficient when a margin-added expected arrival time is later than the departure time, the margin-added arrival time having been obtained by adding a margin value to the expected arrival time.

9. The IC card of claim 8, wherein
the IC card is mounted in a mobile terminal apparatus, the mobile terminal apparatus being connected to an information provision server apparatus and a reservation server apparatus via a network,
the obtaining unit instructs the mobile terminal apparatus to obtain a present location of the mobile terminal apparatus,
the mobile terminal apparatus obtains the present location, extracts the boarding location from the first reservation information stored in the mounted IC card, and transmits the obtained present location and the extracted boarding location to the information provision server apparatus,
the information provision server apparatus receives the present location and the boarding location, calculates the expected arrival time at the boarding location or an approximate time for the user to arrive at the boarding location, with use of the received present location and boarding location, and transmits the calculated expected arrival time or approximate time to the mobile terminal apparatus,
the mobile terminal apparatus receives the expected arrival time, or receives the approximate time and calculates an expected arrival time, and outputs the received expected arrival time to the IC card,
the obtaining unit receives the expected arrival time, and
the changing unit overwrites the stored first reservation information with the second reservation information, and further transmits the second reservation information to the reservation server apparatus via the mobile terminal apparatus.

10. The IC card of claim 9, further comprising:
a present information obtaining unit operable to obtain a time difference between the departure time and a present time, and obtain a distance between the obtained present location and the boarding location; and
a difference judgment unit operable to judge, according to the obtained time difference and the obtained distance, whether or not the margin judgment unit is to perform judgment,
wherein when the difference judgment unit judges that the margin judgment unit is not to perform the judgment, the margin judgment unit suppresses judgment, and the changing unit suppresses overwriting.

11. The IC card of claim 8, further comprising:
a boarding procedure unit operable to perform, with an external apparatus, a procedure for boarding transport, with use of the stored second reservation information.

12. The IC card of claim 11, wherein
the external apparatus is a ticket issuing apparatus that issues tickets for transport,
the boarding procedure unit outputs the stored second reservation information to the ticket issuing apparatus, and
the ticket issuing apparatus receives the second reservation information, and issues a ticket for the transport for which a reservation has been made according to the received second reservation information.

13. The IC card of claim 11, wherein
the external apparatus is a ticket inspection apparatus that inspects tickets at an entry point for boarding a transport,
the boarding procedure unit outputs the stored second information to the ticket inspection apparatus, and
the ticket inspection apparatus receives the second reservation information, inspects content of the received second reservation information, and controls opening and closing of a gate of the ticket inspection apparatus according to a result of the inspection.

14. A mobile terminal apparatus for changing a reservation for purchase of a ticket for a transport that provides a transportation service, comprising a secure unit, the secure unit including:
a storage unit operable to store first reservation information, the first reservation information indicating the reservation and including a boarding location where the transport is to be boarded and a departure time of the transport;
an obtaining unit operable to obtain a present location of the mobile terminal apparatus, extract the boarding location from the first reservation information, and obtain an expected arrival time of a user at the boarding location, with use of the obtained present location and the extracted boarding location;
a margin judgment unit operable to judge whether or not a time margin between the obtained expected arrival time and the departure time included in the first reservation information is sufficient; and
a changing unit operable to, when the time margin is judged not to be sufficient, transmit second reservation information to the reservation server apparatus, the second reservation information indicating a reservation for a ticket for a transport that departs later than the departure time, and store the second reservation information in place of the first reservation information.

15. The mobile terminal apparatus of claim 14, wherein
the margin judgment unit determines that the time margin is insufficient when a margin-added expected arrival time is later than the departure time, the margin added arrival time having been obtained by adding a margin value to the expected arrival time.

16. The mobile terminal apparatus of claim 15, wherein
the obtaining unit obtains the present location by calculating the present location based on range finding signals received from a plurality of GPS satellites.

17. The mobile terminal apparatus of claim 15, wherein
the secure unit is a portable IC card.

18. The mobile terminal apparatus of claim 15, wherein
the secure unit further performs, with an external apparatus, a procedure for boarding transport, using the second reservation information.

19. The mobile terminal apparatus of claim 18, wherein
the external apparatus is a ticket issuing apparatus that issues tickets for transport,
the secure unit of the mobile terminal apparatus outputs the stored second reservation information to the ticket issuing apparatus, and
the ticket issuing apparatus receives the second reservation information, and issues a ticket for the transport for which a reservation has been made according to the received second reservation information.

20. The mobile terminal of claim 18, wherein
the external apparatus is a ticket inspection apparatus that inspects tickets at an entry point for boarding a transport,
the secure unit of the mobile telephone apparatus outputs the stored second information to the ticket inspection apparatus, and
the ticket inspection apparatus receives the second reservation information, inspects content of the received second reservation information, and controls opening and closing of a gate of the ticket inspection apparatus according to a result of the inspection.

21. The mobile terminal apparatus of claim 15, being connected to an information provider server via a network,
wherein the obtaining unit transmits the obtained present location and the extracted boarding location to the information provision server, receives the expected arrival time from the information provision server, or receives an approximate time for the user to arrive at the boarding location from the information provision server and calculates an expected arrival time at the boarding location.

22. A reservation changing method used in a reservation changing apparatus for changing a reservation for purchase of a ticket for a transport that provides a transportation service,
the reservation changing apparatus comprising a secure unit, the secure unit including:
a storage unit operable to store first reservation information, the first reservation information indicating the reservation and including a boarding location where the transport is to be boarded and a departure time of the transport;
an obtaining unit;
a margin judgment unit; and
a changing unit, and
the method comprising:
an obtaining step for the obtaining unit to obtain a present location of the mobile terminal apparatus, extract the boarding location from the first reservation information, and obtain an expected arrival time of a user at the boarding location, with use of the obtained present location and the extracted boarding location;
a margin judgment step for the margin judgment unit to judge whether a time margin between the obtained expected arrival time and the departure time included in the first reservation information is sufficient; and
a changing step for the changing unit, when the time margin is judged not to be sufficient, to transmit second reservation information to a reservation server apparatus, the second reservation information indicating a reservation for a ticket for another transport that departs later than the departure time, and store the second reservation information in place of the stored first reservation information.

23. A computer program for reservation changing used by a reservation changing apparatus for changing a reservation for purchase of a boarding ticket for a transport that provides a transportation service,
the reservation changing apparatus comprising a secure unit, the secure unit including:
a storage unit operable to store first reservation information, the first reservation information indicating the reservation and including a boarding location where the transport is to be boarded and a departure time of the transport;
an obtaining unit;
a margin judgment unit; and
a changing unit, and
the method comprising:
an obtaining step for the obtaining unit to obtain a present location of the mobile terminal apparatus, extract the boarding location from the first reservation information, and obtain an expected arrival time of a user at the boarding location, with use of the obtained present location and the extracted boarding location;
a margin judgment step for the margin judgment unit to judge whether a time margin between the obtained expected arrival time and the departure time included in the first reservation information is sufficient; and
a changing step for the changing unit, when the time margin is judged not to be sufficient, to transmit second reservation information to a reservation server apparatus, the second reservation information indicating a reservation for a ticket for another transport that departs later than the departure time, and store the second reservation information in place of the stored first reservation information.

24. The computer program of claim 23, recorded on a computer-readable recording medium.
